(19) United States
(12) Patent Application Publication
(10) Pub. No.: US 2026/0046919 A1
(43) Pub. Date: Feb. 12, 2026

(54) PRIORITY-AWARE TERRESTRIAL ROAMING

(71) Applicant: Dell Products L.P., Round Rock, TX (US)

(72) Inventor: Ali Esswie, Calgary (CA)

(21) Appl. No.: 18/801,205

(22) Filed: Aug. 12, 2024

(51) Int. Cl. H04W 72/566; H04W 48/16

(52) U.S. Cl. CPC H04W 72/569; H04W 48/16

(57) ABSTRACT

A user equipment may be associated with a guaranteed quality-of-service with respect to a home network. The user equipment may request connection establishment with a terrestrial radio network node corresponding to the home network. The home terrestrial node may configure the user requirement with a roaming priority level, a user equipment priority class corresponding thereto, or an identifier associated with a non-terrestrial radio network node corresponding to a network other than the home network. The home terrestrial node may configure the non-terrestrial node with the user equipment priority class. Upon roaming into signal coverage corresponding to the non-terrestrial node, the user equipment may establish a connection therewith, based on the priority class, that facilitates communicating according to the guaranteed quality-of-service. If connection establishment with the non-terrestrial node fails, the user equipment may establish connection with a roaming terrestrial node based on a roaming priority level indication broadcast thereby.

### REFERENCE TO RELATED APPLICATIONS

The subject patent application is related to U.S. patent application Ser. No. ------, filed ------, and entitled “FAST DEVICE ROAMING SWITCHING” (docket no. 139245.01/DELLP1299US) and U.S. patent application Ser. No. ------, filed ------, and entitled “PROACTIVE NON-TERRESTRIAL ROAMING FOR UBIQUITOUS CONNECTIVITY SERVICES” (docket no. 139246.01/DELLP1300US), the entireties of which applications are hereby incorporated by reference herein.

### BACKGROUND

The ‘New Radio’ (NR) terminology that is associated with fifth generation mobile wireless communication systems (“5G”) refers to technical aspects used in wireless radio access networks (“RAN”) that comprise several quality-of-service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise, based on roaming priority information comprising at least one roaming priority indication indicative of at least one roaming priority associated with at least one quality-of-service, determining, by a first radio network node comprising at least one processor, at least one roaming priority that corresponds to at least one user equipment to result in at least one determined roaming priority. The method may further comprise facilitating, by the first radio network node, transmitting, to the at least one user equipment, user equipment roaming information to be usable by the at least one user equipment to facilitate roaming delivery of traffic with respect to at least one second radio network node according to at least one of the at least one quality-of-service associated with the at least one determined roaming priority.

The roaming priority information may be received by the first radio network node from at least one network element associated with a core network. The user equipment roaming information may comprise a determined priority indication indicative of the at least one determined roaming priority. The at least one determined roaming priority may correspond to a preferred quality-of-service that the at least one second radio network node is configured to accommodate with respect to the at least one user equipment.

The user equipment roaming information may comprise at least one non-terrestrial radio network node identifier indicative of the at least one second radio network node.

The user equipment roaming information may comprise a user equipment roaming class indication, indicative of at least one user equipment roaming class, corresponding to the at least one determined roaming priority, to be usable by the at least one user equipment to determine to request connection establishment with the at least one second radio network node.

In an example embodiment, the method may further comprise facilitating, by the first radio network node, transmitting, to the at least one second radio network node, a user equipment roaming class indication, indicative of at least one user equipment roaming class, corresponding to the at least one determined roaming priority, to be usable by the at least one second radio network node, to determine at least one quality-of-service profile usable by the at least one second radio network node to facilitate a roaming communication session with the at least one user equipment according to the at least one of the at least one quality-of-service associated with the at least one determined roaming priority.

In an example embodiment, the first radio network node may be a terrestrial radio network node. The at least one second radio network node may be a non-terrestrial radio network node.

In an example embodiment, the method may further comprise facilitating, by the first radio network node, transmitting, to at least one of the at least one second radio network node, at least one of the at least one roaming priority indication to be indicative of at least one of the at least one roaming priority with respect to which the at least one second radio network node is to facilitate at least one communication session with the at least one user equipment. The at least one second radio network node may be configured to facilitate broadcasting the at least one of the at least one roaming priority indication via at least one of: at least one master information block signal, or at least one system information block signal. The first radio network node may be a terrestrial radio network node. The at least one second radio network node may be at least one terrestrial radio network node.

In another example embodiment, a terrestrial radio network node may comprise at least one processor configured to process executable instructions that, when executed by the at least one processor, may facilitate performance of operations that may comprise receiving, from core network equipment, roaming priority information comprising at least one roaming priority indication respectively associated with at least one quality-of-service indication, determining, from the roaming priority information, a roaming priority that corresponds to a session quality-of-service associated with a communication session with a user equipment to result in a determined roaming priority, and transmitting, to the user equipment, user equipment roaming information to be usable by the user equipment to facilitate roaming delivery of traffic according to the session quality-of-service.

In an example embodiment, the terrestrial radio network node may be a serving terrestrial radio network node. The user equipment roaming information may comprise a determined user equipment roaming priority indication indicative of the determined roaming priority. The determined roaming priority may correspond to a preferred, or subscribed-to, quality-of-service that at least one roaming terrestrial radio network node, other than the serving terrestrial radio network node, is configured to accommodate with respect to the user equipment. The operations may further comprise transmitting, to the at least one roaming terrestrial radio network node, at least one roaming priority indication to be indicative, to the at least one roaming terrestrial radio network node, of at least the determined roaming priority with respect to which the at least one roaming terrestrial radio network node is to facilitate the communication session according to the session quality-of-service.

In an example embodiment, the user equipment roaming information may comprise a user equipment roaming class indication indicative of a user equipment roaming class, corresponding to the determined roaming priority, to be usable by the user equipment to determine to request connection establishment with a non-terrestrial radio network node.

In an example embodiment, the operations may further comprise transmitting, to a non-terrestrial radio network node, at least one user equipment roaming class indication to be indicative to the non-terrestrial radio network node of at least one user equipment roaming class to be usable by the non-terrestrial radio network node to determine a quality-of-service profile to facilitate a roaming communication session with the user equipment according to the session quality-of-service.

In yet an example embodiment, a non-transitory machine-readable medium may comprise executable instructions that, when executed by at least one processor of first radio network equipment, may facilitate performance of operations that may comprise receiving, from core network equipment, roaming priority information comprising at least one roaming priority indication respectively associated with at least one quality-of-service indication and receiving a connection establishment request from a user equipment. Responsive to the connection establishment request, the operations may further comprise establishing a connection with the user equipment to result in an established connection and facilitating a communication session, according to a session quality-of-service, with the user equipment via the established connection. The operations may further comprise transmitting, to the user equipment, user equipment roaming information to be usable by the user equipment to facilitate roaming delivery of traffic with respect to second radio network equipment according to the session quality-of-service.

In an example embodiment, the operations may further comprise, based on the roaming priority information, determining at least one user equipment roaming priority that corresponds to the session quality-of-service to result in at least one determined user equipment roaming priority. The user equipment roaming information may comprise a determined user equipment roaming priority indication indicative of the at least one determined user equipment roaming priority. The at least one determined user equipment roaming priority may correspond to a preferred quality-of-service that the second radio network equipment is configured to accommodate with respect to the user equipment. The second radio network equipment may correspond to a terrestrial radio network node.

In an example embodiment, the user equipment roaming information may comprise a user equipment roaming class indication, that may be indicative of at least one user equipment roaming class, that may be usable by the user equipment to determine to request connection establishment from the second radio network equipment. The second radio network equipment may correspond to a non-terrestrial radio network node.

In an example embodiment, the operations may further comprise transmitting, to the non-terrestrial radio network node, the user equipment roaming class indication to be indicative to the non-terrestrial radio network node of at least one user equipment roaming class to be usable by the non-terrestrial radio network node to determine a quality-of-service profile to facilitate a roaming communication session with the user equipment according to the session quality-of-service.

In an example embodiment, a method may comprise roaming, by at least one user equipment comprising at least one processor, within at least one signal coverage region corresponding to at least one roaming radio network node. Based on user equipment roaming information usable by the at least one user equipment to facilitate roaming delivery of traffic according to at least one quality-of-service, the method may further comprise determining, by the at least one user equipment, at least one of the at least one roaming radio network node that is configured to deliver traffic with respect to the at least one user equipment according to the at least one quality-of-service to result in at least one determined roaming radio network node. The method may further comprise facilitating, by the at least one user equipment, establishing, with at least one of the at least one determined roaming radio network node, a connection that is capable of facilitating delivery of traffic according to the at least one quality-of-service to result in an established connection.

In an example embodiment, the method may further comprise facilitating, by at least one user equipment, receiving, from a home radio network node corresponding to a home radio network with which the at least one user equipment is associated, the user equipment roaming information.

The at least one roaming radio network node may correspond to a radio network that is not associated with the at least one user equipment. The user equipment roaming information may comprise at least one roaming priority indication indicative of at least one roaming priority corresponding to the at least one quality-of-service. In an embodiment, the determining of the at least one determined roaming radio network node may comprise facilitating, by the at least one user equipment, receiving, from the at least one roaming radio network node, the at least one roaming priority indication indicative that the at least one roaming radio network node is configured to facilitate communicating traffic with the at least one user equipment according to the at least one quality-of-service corresponding to the at least one roaming priority. The at least one roaming priority indication may be received via at least one of: at least one master information block signal broadcast by the at least one roaming radio network node, or at least one system information block signal broadcast by the at least one roaming radio network node. The at least one roaming radio network node may comprise at least one terrestrial radio network node.

In an example embodiment, the user equipment roaming information may comprise at least one of: at least one user equipment roaming class indication indicative of at least one user equipment roaming class associated with at least one roaming priority associated with the at least one user equipment. The at least one roaming priority may correspond to the at least one quality-of-service, or at least one non-terrestrial radio network node identifier associated with at least one non-terrestrial radio network node.

In an embodiment, the at least one roaming radio network node may comprise the at least one non-terrestrial radio network node. The determining of the at least one determined roaming radio network node may comprise facilitating, by the at least one user equipment, receiving, from the at least one non-terrestrial radio network node, at least one transmitted non-terrestrial radio network node indication indicative of the at least one non-terrestrial radio network node and determining, by the at least one user equipment, that the user equipment roaming information comprises the at least one transmitted non-terrestrial radio network node indication. Based on the user equipment roaming information being determined to comprise the at least one transmitted non-terrestrial radio network node indication, the method may further comprise determining, by the at least one user equipment, the at least one non-terrestrial radio network node corresponding to the at least one transmitted non-terrestrial radio network node indication to be the at least one determined roaming radio network node.

In an embodiment, the determining of the at least one determined roaming radio network node may further comprise determining, by the at least one user equipment, at least one first signal strength corresponding to at least one terrestrial radio network node to result in at least one determined first signal strength and determining, by the at least one user equipment, at least one second signal strength corresponding to the at least one determined roaming radio network node to result in at least one determined second signal strength. The method may further comprise determining, by the at least one user equipment, that the at least one determined first signal strength equals or exceeds the at least one determined second signal strength and determining, by the at least one user equipment, that the at least one terrestrial radio network node is not configured to accommodate delivery of traffic with respect to the at least one user equipment according to the at least one quality-of-service. Based on the at least one terrestrial radio network node being determined to not be configured to accommodate delivery of traffic with respect to the at least one user equipment according to the at least one quality-of-service, the method may further comprise disregarding, by the at least one user equipment, the at least one determined first signal strength being determined to equal or exceed the at least one determined second signal strength, and further determining, by the at least one user equipment, the at least one non-terrestrial radio network node corresponding to the at least one transmitted non-terrestrial radio network node indication to be the at least one determined roaming radio network node.

In an embodiment, the method may further comprise facilitating, by the at least one user equipment, transmitting, to the at least one determined roaming radio network node, the at least one user equipment roaming class indication to be usable by the at least one determined roaming radio network node to facilitate the establishing the established connection.

In an embodiment, the at least one quality-of-service may be associated with the at least one user equipment based on, or according to, at least one subscription corresponding to the at least one user equipment.

In another example embodiment, a user equipment may comprise at least one processor configured to process executable instructions that, when executed by the at least one processor, may facilitate performance of operations that may comprise receiving, from a first radio network node, user equipment roaming information to be usable by the user equipment to facilitate roaming delivery of traffic with respect to at least one second radio network node according to at least one quality-of-service associated with the user equipment, and roaming within at least one signal coverage region corresponding to at least one of the at least one second radio network node. Based on the user equipment roaming information, the operations may further comprise determining at least one of the at least one second radio network node that is configured to deliver traffic with respect to the user equipment according to the at least one quality-of-service to result in at least one determined roaming radio network node. The operations may further comprise establishing with at least one of the at least one determined roaming radio network node, a connection that is capable of facilitating delivery of traffic according to the at least one quality-of-service to result in an established connection.

In an embodiment, the determining of the at least one determined roaming radio network node may comprise receiving, from the at least one second radio network node, at least one roaming priority indication indicative that the at least one determined roaming radio network node is configured to facilitate communicating traffic with the user equipment according to the at least one quality-of-service corresponding to the at least one roaming priority indication.

In an embodiment, the at least one second radio network node may comprise at least one non-terrestrial radio network node. The determining of the at least one determined roaming radio network node may comprise receiving, from the at least one non-terrestrial radio network node, at least one transmitted non-terrestrial radio network node indication indicative of the at least one non-terrestrial radio network node, and determining, by the user equipment, that the user equipment roaming information comprises the at least one transmitted non-terrestrial radio network node indication. Based on the user equipment roaming information being determined to comprise the at least one transmitted non-terrestrial radio network node indication, the operations may further comprise determining, by the user equipment, the at least one non-terrestrial radio network node corresponding to the at least one transmitted non-terrestrial radio network node indication to be the at least one determined roaming radio network node.

In an embodiment, the determining of the at least one determined roaming radio network node further may comprise determining at least one first signal strength corresponding to at least one terrestrial radio network node to result in at least one determined first signal strength and determining at least one second signal strength corresponding to the at least one determined roaming radio network node to result in at least one determined second signal strength. The operations may comprise determining that the at least one determined first signal strength equals or exceeds the at least one determined second signal strength. The operations may further comprise receiving, from the at least one terrestrial radio network node, at least one roaming priority indication indicative of at least one roaming priority associated with the user equipment. Based on the at least one roaming priority indication, the operations may further comprise determining that the at least one terrestrial radio network node is not configured to accommodate delivery of traffic with respect to the user equipment according to the at least one quality-of-service. Based on the at least one terrestrial radio network node being determined to not be configured to accommodate delivery of traffic with respect to the user equipment according to the at least one quality-of-service, the operations may further comprise disregarding, by the user equipment, the at least one determined first signal strength being determined to equal or exceed the at least one determined second signal strength and further determining the at least one non-terrestrial radio network node corresponding to the at least one transmitted non-terrestrial radio network node indication to be the at least one determined roaming radio network node. The operations may further comprise transmitting, to the at least one determined roaming radio network node, at least one user equipment roaming class indication, indicated by the user equipment roaming information, to be usable by the at least one determined roaming radio network node to facilitate the establishing the established connection.

In yet another example embodiment, a non-transitory machine-readable medium may comprise executable instructions that, when executed by at least one processor of a user equipment, may facilitate performance of operations that may comprise receiving, from a home terrestrial radio network node, user equipment roaming information to be usable by the user equipment to facilitate roaming delivery of traffic with respect to at least one roaming radio network node according to at least one quality-of-service associated with the user equipment and roaming within at least one signal coverage region corresponding to at least one of the at least one roaming radio network node. Based on the user equipment roaming information, the operations may further comprise determining at least one of the at least one roaming radio network node that is configured to deliver traffic with respect to the user equipment according to the at least one quality-of-service to result in at least one determined roaming radio network node. The operations may further comprise establishing, with at least one of the at least one determined roaming radio network node, a connection that is capable of facilitating delivery of traffic according to the at least one quality-of-service to result in an established connection.

The user equipment roaming information may comprise at least one of: at least one roaming priority indication indicative of at least one roaming priority associated with the user equipment, wherein the at least one roaming priority corresponds to the at least one quality-of-service, at least one user equipment roaming class indication indicative of at least one user equipment roaming class associated with the at least one roaming priority, or at least one non-terrestrial radio network node identifier associated with at least one non-terrestrial radio network node.

The at least one roaming radio network node may comprise at least one non-terrestrial radio network node. The determining of the at least one determined roaming radio network node may comprise receiving, from the at least one non-terrestrial radio network node, at least one transmitted non-terrestrial radio network node indication indicative of the at least one non-terrestrial radio network node, and determining that the user equipment roaming information comprises the at least one transmitted non-terrestrial radio network node indication. Based on the user equipment roaming information being determined to comprise the at least one transmitted non-terrestrial radio network node indication, the operations may further comprise determining the at least one non-terrestrial radio network node corresponding to the at least one transmitted non-terrestrial radio network node indication to be the at least one determined roaming radio network node.

In an embodiment, the operations may further comprise failing to establish a connection, capable of facilitating roaming delivery of traffic corresponding to the at least one quality-of-service, with the at least one non-terrestrial radio network node associated in the user equipment roaming information with the at least one non-terrestrial radio network node identifier to result in non-establishment of a non-terrestrial roaming connection. The determining of the at least one determined roaming radio network node may comprise, based on the non-establishment of the non-terrestrial roaming connection, receiving, from at least one roaming terrestrial radio network node, at least one roaming priority indication indicative that the at least one roaming terrestrial radio network node is configured to facilitate communicating traffic with the user equipment according to the at least one quality-of-service corresponding to the at least one roaming priority.

In an example embodiment, a method may comprise facilitating, by at least one radio network node comprising at least one processor, receiving user equipment roaming information directed to the at least one radio network node by at least one network equipment element communicatively coupled with the at least one radio network node and facilitating, by the at least one radio network node, receiving, from at least one user equipment, at least one roaming connection establishment request to establish a connection capable of accommodating a quality-of-service associated with the at least one user equipment. The method may further comprise determining, by the at least one radio network node, that the at least one roaming connection establishment request comprises user equipment information indicative that the at least one radio network node is capable of, or is to be capable of, facilitating roaming delivery of traffic with respect to the at least one user equipment according to the quality-of-service to result in a determined quality-of-service. Based on the user equipment information being determined to be indicative of the determined quality-of-service, the method may further comprise facilitating, by the at least one radio network node, performing a connection establishment action, with the at least one user equipment, to establish a connection capable of accommodating roaming delivery of traffic with respect to the at least one user equipment according to the determined quality-of-service.

In an embodiment, the method may further comprise facilitating, by the at least one radio network node, broadcasting at least one roaming priority indication indicative that the at least one radio network node is configured to facilitate communicating traffic with the at least one user equipment according to the determined quality-of-service. Responsive to the broadcasting the at least one roaming priority indication, the method may further comprise facilitating, by the at least one radio network node, receiving, from the at least one user equipment, the at least one roaming connection establishment request.

The at least one radio network node may be a non-terrestrial radio network node.

In an embodiment, the user equipment information received via the at least one roaming connection establishment request may comprise at least one roaming priority indication indicative of at least one roaming priority associated, in the user equipment roaming information, with the determined quality-of-service.

In an embodiment, the at least one radio network node may be configured to facilitate broadcasting the at least one roaming priority indication via at least one of: at least one master information block signal, or at least one system information block signal. The at least one radio network node may comprise at least one terrestrial radio network node.

In an embodiment, the at least one roaming connection establishment request may comprise at least one user equipment roaming class indication indicative of at least user equipment roaming priority corresponding to the at least one user equipment. The determining of the determined quality-of-service may be based on the at least on user equipment roaming priority indicated by the at least one user equipment roaming class indication being associated, in the user equipment roaming information, with the determined quality-of-service.

In an embodiment, the performing of the connection establishment action may comprise retrieving, from a memory corresponding to the at least one radio network node or via the at least one network equipment element, quality-of-service configuration information usable, by the at least one radio network node, to facilitate establishing the connection capable of accommodating roaming delivery of traffic with respect to the at least one user equipment according to the determined quality-of-service.

In an embodiment, the at least one roaming connection establishment request may comprise at least one user equipment roaming class indication indicative of at least user equipment roaming priority corresponding to the determined quality-of-service. The performing of the connection establishment action may comprise, based on the at least user equipment roaming priority, determining at least one radio bearer capable of facilitating the determined quality-of-service to result in at least one determined radio bearer. The method may further comprise facilitating establishing, with the at least one user equipment, at least one connection via the at least one determined radio bearer.

In an embodiment, the at least one roaming connection establishment request may comprise at least one user equipment roaming class indication indicative of at least user equipment roaming priority corresponding to the determined quality-of-service. The performing of the connection establishment action may comprise, based on the at least user equipment roaming priority, determining at least one radio bearer capable of facilitating the determined quality-of-service to result in at least one determined radio bearer. The method may further comprise foregoing establishing, with the at least one user equipment, at least one connection via the at least one determined radio bearer. The method may further comprise facilitating, by the at least one radio network node, transmitting, to the at least one user equipment, a connection failure indication indicative of the failing to establish at least one connection via the at least one determined radio bearer to facilitate the determined quality-of-service. The at least one radio network node may be a first radio network node. The at least one roaming connection establishment request may be a first roaming connection establishment request. The connection failure indication may be usable by the at least one user equipment to determine to transmit, to a second radio network node, a second roaming connection establishment request. The first radio network node may be a non-terrestrial radio network node. The second radio network node may be a terrestrial radio network node.

In another example embodiment, a radio network node may comprise at least one processor configured to process executable instructions that, when executed by the at least one processor, may facilitate performance of operations that may comprise receiving user equipment roaming information directed to the radio network node by at least one network equipment element communicatively coupled with the radio network node and receiving, from a user equipment, a roaming connection establishment request, comprising user equipment priority information corresponding to a quality-of-service associated with the user equipment, to establish a roaming connection capable of accommodating the quality-of-service. The operations may further comprise analyzing the user equipment priority information with respect to the user equipment roaming information to result in analyzed user equipment priority information and determining that the analyzed user equipment priority information corresponds to the radio network node being configured to facilitate roaming delivery of traffic with respect to the user equipment according to the quality-of-service to result in a determined quality-of-service. Based on the analyzed user equipment priority information being determined to be indicative of the determined quality-of-service, the operations may further comprise performing a connection establishment action, with the user equipment, to establish a connection capable of accommodating roaming delivery of traffic with respect to the user equipment according to the quality-of-service.

In an embodiment, the radio network node may be a terrestrial radio network node. The operations may further comprise broadcasting at least one roaming priority indication indicative that the radio network node is configured to facilitate communicating traffic with the user equipment according to the quality-of-service. Responsive to the broadcasting the at least one roaming priority indication the operations may further comprise receiving, from the user equipment, the roaming connection establishment request.

In an embodiment, the roaming connection establishment request may comprise a user equipment roaming class indication indicative of a user equipment roaming priority corresponding to the quality-of-service. The performing of the connection establishment action may comprise, based on the user equipment roaming priority, determining at least one radio bearer capable of facilitating the quality-of-service to result in at least one determined radio bearer. The operations may further comprise establishing, with the user equipment, a connection via the at least one determined radio bearer.

In an embodiment, the roaming connection establishment request may comprise a user equipment roaming class indication indicative of a user equipment roaming priority corresponding to the quality-of-service. The performing of the connection establishment action may comprise, based on the user equipment roaming priority, determining at least one radio bearer capable of facilitating the quality-of-service to result in at least one determined radio bearer. The performing of the connection establishment action may further comprise failing to establish, with user equipment, at least one connection via the at least one determined radio bearer and transmitting, to the user equipment, a connection failure indication indicative of the failing to establish at least one connection via the at least one determined radio bearer to facilitate the quality-of-service. The radio network node may be a non-terrestrial radio network node. The roaming connection establishment request may be a first roaming connection establishment request. The connection failure indication may be usable by the user equipment to determine to transmit, to a terrestrial radio network node, a second roaming connection establishment request requesting establishment of a terrestrial roaming connection.

In yet another example embodiment, a non-transitory machine-readable medium may comprise executable instructions that, when executed by at least one processor of non-terrestrial radio network equipment, may facilitate performance of operations that may comprise receiving user equipment roaming information directed to the non-terrestrial radio network equipment by at least one network equipment element communicatively coupled with the non-terrestrial radio network equipment and receiving, from a user equipment, a roaming connection establishment request, comprising a user equipment roaming class indication indicative of a user equipment roaming priority corresponding to a quality-of-service associated with the user equipment, to establish a roaming connection capable of accommodating the quality-of-service. The operations may further comprise analyzing the user equipment roaming priority with respect to the user equipment roaming information to result in an analyzed user equipment roaming priority and determining that the analyzed user equipment roaming priority corresponds to the non-terrestrial radio network equipment being configured to facilitate roaming delivery of traffic with respect to the user equipment according to the quality-of-service to result in a determined quality-of-service. Based on the analyzed user equipment roaming priority being determined to be indicative of the determined quality-of-service, the operations may further comprise performing a connection establishment action, with the user equipment, to establish a connection capable of accommodating roaming delivery of traffic with respect to the user equipment according to the determined quality-of-service.

In an embodiment, the performing of the connection establishment action may comprise, based on the user equipment roaming priority, determining at least one radio bearer capable of facilitating the determined quality-of-service to result in at least one determined radio bearer and establishing, with the user equipment, a connection via the at least one determined radio bearer to result in an established connection. The connection establishment action may further comprise delivering roaming traffic with the user equipment via the established connection according to the determined quality-of-service.

In an embodiment, the performing the connection establishment action may comprise, based on the user equipment roaming priority, determining at least one radio bearer capable of facilitating the determined quality-of-service to result in at least one determined radio bearer and failing to establish, with the user equipment, at least one connection via the at least one determined radio bearer. The performing the connection establishment action may further comprise transmitting, to the user equipment, a connection failure indication indicative of the failing to establish at least one connection via the at least one determined radio bearer to facilitate the determined quality-of-service.

### BRIEF DESCRIPTION OF THE DRAWINGS

FIG. 1 illustrates wireless communication system environment.

FIG. 2 illustrates an environment with a satellite base station/gateway and satellite that are capable of communication of traffic corresponding to a radio access network.

FIG. 3 illustrates an example environment with a non-terrestrial radio network node facilitating roaming of user equipment.

FIG. 4 illustrates example roaming priority information.

FIG. 5 illustrates example user equipment roaming information.

FIG. 6 illustrates example user equipment roaming class information.

FIG. 7 illustrates example user equipment roaming priority information.

FIG. 8 illustrates example prioritizing of roaming configuration information.

FIG. 9 illustrates example fast-roaming connection establishment request information.

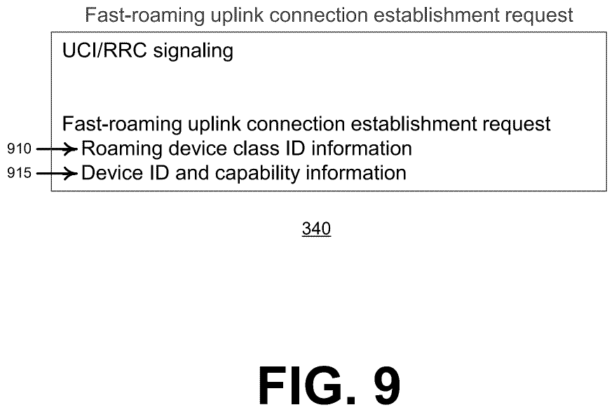

FIG. 10 illustrates a timing diagram of a terrestrial radio network node facilitating roaming via a non-terrestrial radio network node.

FIG. 11 illustrates a timing diagram of a roaming user equipment.

FIG. 12 illustrates a timing diagram of a non-terrestrial radio network node facilitating roaming of user equipment.

FIG. 13 illustrates a flow diagram of an example method to facilitate roaming of user equipment by a non-terrestrial radio network node.

FIG. 14 illustrates a block diagram of an example method.

FIG. 15 illustrates a block diagram of an example terrestrial radio network node.

FIG. 16 illustrates a block diagram of an example non-transitory machine-readable medium.

FIG. 17 illustrates a block diagram of an example method.

FIG. 18 illustrates a block diagram of an example user equipment.

FIG. 19 illustrates a block diagram of an example non-transitory machine-readable medium.

FIG. 20 illustrates a block diagram of an example method.

FIG. 21 illustrates a block diagram of an example non-terrestrial radio network node equipment.

FIG. 22 illustrates a block diagram of an example non-transitory machine-readable medium.

FIG. 23 illustrates an example computer environment.

FIG. 24 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Artificial intelligence (“AI”) and machine learning (“ML”) models may facilitate performance and operational functionality and improvements in 5G implementation, such as, for example, network automation, optimizing signaling overhead, energy conservation at devices, and traffic-capacity maximization. An artificial intelligence machine learning models (“AI/ML model”) functionality can be implemented and structured in many different forms and with varying vendor-proprietary designs. A 5G radio access network node (“RAN”) of a network to which the user equipment may be attached or with which the user equipment may be registered may manage or control real-time AI/ML model performance at different user equipment devices for various radio functions.

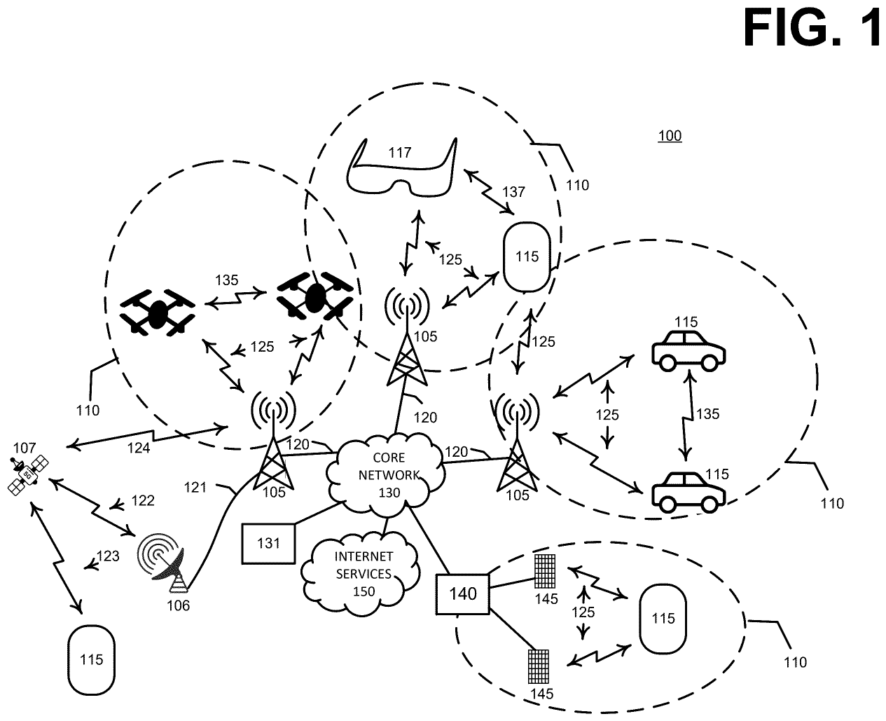

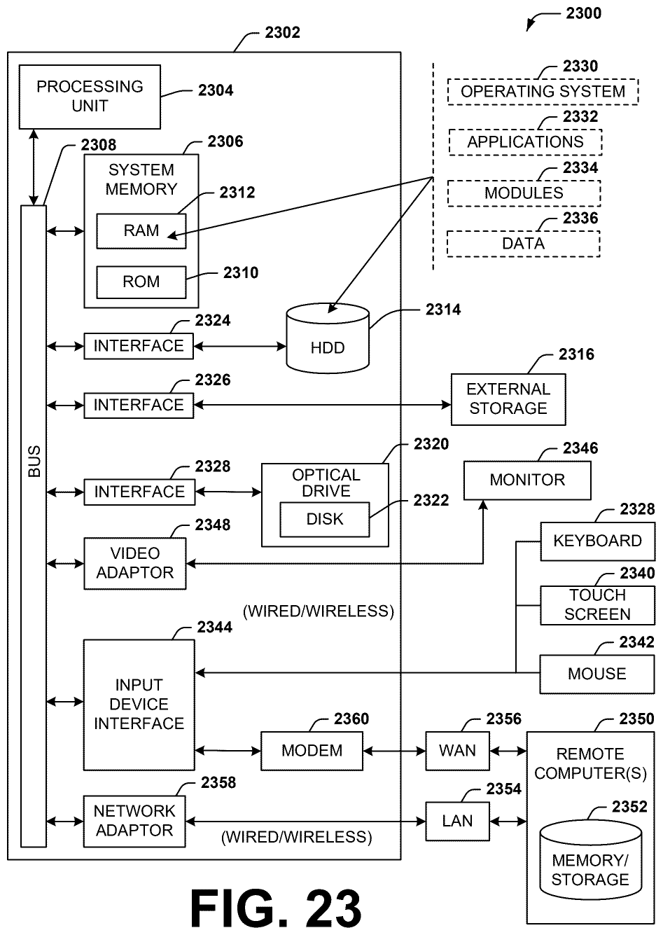

Turning now to the figures, FIG. 1 illustrates an example of a wireless communication system 100 that supports blind decoding of PDCCH candidates or search spaces in accordance with aspects of the present disclosure. The wireless communication system 100 may include one or more base stations 105, one or more UEs 115, and core network 130. In some examples, the wireless communication system 100 may be a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, automobiles or other vehicles, or drones or other aircraft. Another example of a UE may be a virtual reality appliance 117, such as smart glasses, a virtual reality headset, an augmented reality headset, and other similar devices that may provide images, video, audio, touch sensation, taste, or smell sensation to a wearer. A UE, such as VR appliance 117, may transmit or receive wireless signals with a RAN base station 105 via a long-range wireless link 125, or the UE/VR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. VR appliance 117 may also communicate with a wireless UE via a cable, or other wired connection. A RAN, or a component thereof, may be implemented by one or more computer components that may be described in reference to FIG. 23.

Continuing with discussion of FIG. 1, base stations 105 may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and Nr may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHZ), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The evolution of communication networks has witnessed remarkable advancements over the past decades. A significant extension of 5G's potential may lie beyond the conventional terrestrial infrastructure, giving rise to what are known as Non-Terrestrial Networks (“NTN”).

Non-Terrestrial Networks may encompass a diverse range of technologies and architectures that may comprise space-based, airborne, and maritime platforms to enhance global communication capabilities. Integration of 5G and non-terrestrial environments may facilitate connectivity being established, maintained, and optimized to remote and underserved regions.

Satellites equipped with 5G capabilities constitute an aspect of 5G NTN. Satellites, positioned in low Earth orbit (“LEO”), medium Earth orbit (“MEO”), or geostationary orbit (“GEO”), may form an intricate web of interconnected nodes. The satellites can provide widespread coverage, offering high-speed data connections, low latency communication, and global mobility. Satellites may facilitate broadband access in rural and remote areas, disaster-stricken regions, and on moving vehicles, ships, and aircraft, thus bridging the digital divide.

Satellite-based NTN can bridge connectivity gaps in remote and rural areas, provide disaster recovery communication, and offer enhanced coverage for maritime and aeronautical services. High-altitude platforms and drones equipped with cellular capabilities can serve as temporary network relays for events, emergencies, or areas with signal-strength coverage deficiencies. such applications may benefit not only traditional voice and data services but also for technologies, such as, for example, Internet of Things (“IoT”), wherein connectivity is typically a desirable, or a fundamental requirement.

A non-terrestrial base station 106, which may comprise a satellite antenna, may be coupled to core network 130. Non-terrestrial base station 106 may communicate with satellite 107, which may communicate with a user equipment 115. Non-terrestrial base station 106, which may be referred to as a non-terrestrial network gateway, and satellite 107 may facilitate delivering traffic corresponding to a radio access network, which may comprise RAN nodes 105, core network 130, backhaul links 120, and long-range wireless links 125, to user equipment that may be located beyond coverage of a RAN node 105. Links 121 between RAN nodes 105 and satellite base station/gateway 106 may comprise coaxial, fiber, or wireless links that may be similar to links 120. Links 122 and 124 to satellite node 107, and links 123 from satellite/node 107 to UE 115, may comprise line-of-sight microwave signal transmission. A UE 115 may be configured with at least one antenna, or at least one processor, to facilitate transmitting or receiving microwave signals to/from satellite node 107. Description herein of, or reference herein to, a radio node or a radio network node may be a description of or a reference to either a terrestrial RAN node 105, a non-terrestrial gateway 106, a non-terrestrial satellite node 107, or a combination of one or more of a terrestrial RAN node, a non-terrestrial gateway, or a non-terrestrial satellite. A terrestrial radio network node may be referred to as a “TN” node. Reference to a satellite node, or a non-terrestrial network node (“NTN node”), may comprise a reference to satellite 107, base station gateway 106, or a combination of satellite 107 and base station/gateway 106.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

It will be appreciated that although an NTN node may benefit the most from embodiments disclosed herein, techniques disclosed herein may be of benefit to a ground-based RAN node. Thus, use of “radio network node” may be interpreted as referring to a ground-based RAN node or to a satellite node, which may comprise a gateway 106 or a satellite 107.

NTNs can enhance the limited coverage of ground RANs, which makes NTNs cost efficient in remote rural areas, mountainous areas, and generally where ground cellular deployments are either not possible or not cost efficient.

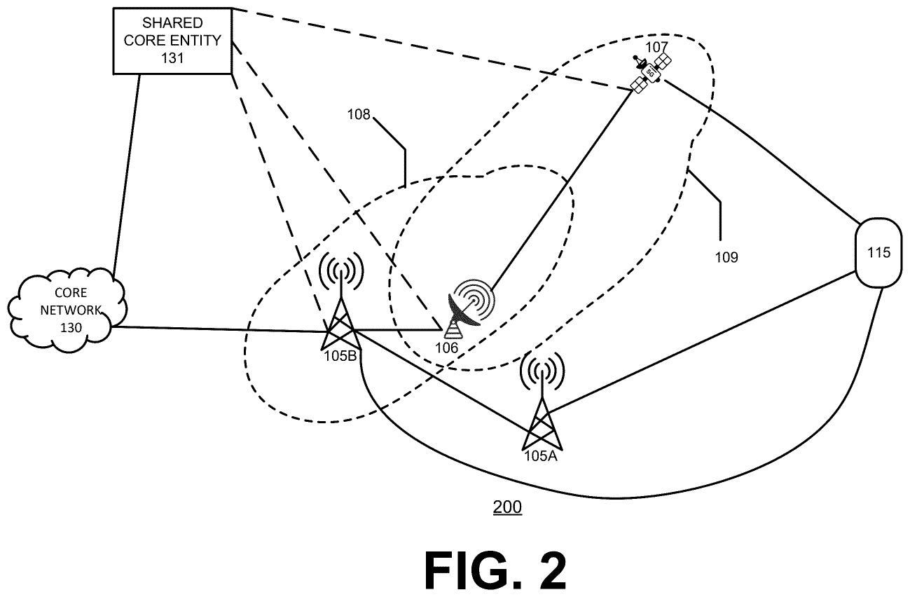

Turning now to FIG. 2, the figure illustrates ground-based RAN node 105, base station 106, and NTN node 107, any one or more of which may be referred to as a radio network node. In reference to some embodiments disclosed herein, reference to a TN node may comprise a reference to node 108, which may comprise one or more of terrestrial RAN node 105 or gateway 106. In reference to some embodiments disclosed herein, reference to an NTN node may comprise a reference to node 109, which may comprise one or more of gateway 106 or satellite 107. In some embodiments, a communication session with UE 115 may be served by RAN node 105. RAN node 105 may communicate directly with satellite node 107 via communication links 124 or via gateway 106 via links 121 and 122.

It may be desirable to implement gNodeB/RAN node functionality on board an NTN node/satellite node to serve user equipment. However, implementing RAN node functionality in an NTN node may give rise to performance limitations that may impact overall operation. For example, an NTN node implementing gNodeB functionality may consume energy at a rate similar to, or greater than, an energy consumption rate corresponding to a terrestrial RAN node due to providing similar functionality as the terrestrial node but providing the functionality to a potentially much larger number of user equipment because of a much wider coverage area corresponding to a non-terrestrial node with respect to a coverage area corresponding to a terrestrial node. Moreover, a non-terrestrial network node typically operates with a more limited energy source (e.g., a battery) as compared to an energy source corresponding to a terrestrial node (e.g., connection to a local electric power grid).

Therefore, it may be desirable to offload energy-consumption-heavy radio operations from an NTN node to a terrestrial node if power consumed by an NTN/satellite node is deemed excessive or poses a risk to the NTN node/satellite (e.g., tending to cause a dead battery at the NTN node). It may be desirable to facilitate controlling energy consumption of an NTN satellite node while offering full radio access network node functionality to user equipment devices.

Global roaming may be desirable functionality, wherein a user equipment can retain wireless cellular connectivity when moving from being covered by a primary, or ‘home’, network corresponding to a home service provider to a visited network, which might occur, for example, when traveling to another country served by another service provider than the home service provider. Due to lack of seamless integration among home and visited networks, user equipment operating with respect to visited networks other than a home network, which visited networks may be referred to as roaming networks, are typically served on a best effort basis regardless of quality-of-service level(s) or connectivity reliability level(s) that may be guaranteed by the home network when the user equipment operates on the home network. Accordingly, disruption of connection and communication session(s) while roaming may occur with respect to a user equipment that may have subscribed to an ‘all-time connected’ guaranteed minimum quality-of-service level and a connection reliability level. To solve problems related to degraded quality-of-service and connectivity that may occur while a user equipment operates on, or with, a roaming network, or a roaming network node corresponding thereto, embodiments disclosed herein may facilitate a terrestrial and non-terrestrial joint solution that may facilitate smooth, QoS-guaranteed all-time, or ubiquitous, roaming connectivity and traffic delivery. For example, embodiments disclosed herein may facilitate user equipment associated with critical QoS requirements (e.g., a ‘VIP’ subscription for all-time roaming connectivity according to at least a minimum QoS level) operating according to QoS requirements (e.g., minimum data rate, maximum tolerated radio latency, radio reliability, etc.) when globally moving away from/roaming away from a home network corresponding to the user equipment and operating within at least one signal coverage region corresponding to one or more non-terrestrial network nodes corresponding to one or more non-terrestrial networks that may be configured to, or that may be capable of, facilitating QoS-guaranteed radio services in accordance with the VIP levels that are subscribed to with respect to the user equipment.

According to example embodiments disclosed herein, a terrestrial radio network node may first determine QoS requirements corresponding to a particular user equipment device. Based on determining a guaranteed all-time-all-places-available QoS or connectivity level, which may be based on a subscription associated with a user equipment, a home terrestrial RAN node may determine a roaming device class, which may be coordinated among the home terrestrial RAN node and remote/roaming NTN networks. A roaming device class may be associated with a minimum determined QoS to be always guaranteed either locally with respect to the primary home terrestrial RAN network and/or with respect to a visited/roaming NTN network. A home terrestrial RAN node may proactively configure user equipment devices with all-time user equipment roaming information including information indicative of a guaranteed QoS to be facilitated by visited networks. A home terrestrial RAN node may facilitate coordinating user equipment information corresponding to the user equipment with at least one non-terrestrial RAN networks via which a guaranteed QoS is to be facilitated. User equipment information may comprise indication of a roaming device class corresponding to the user equipment. Thus, when user equipment moves away from, or roams away from, a primary/home network, the user equipment is enabled to immediately camp on a roaming network, wherein roaming operation that is typically complex according to conventional techniques may be effectively transformed into a simple proactive handover operation according to embodiments disclosed herein.

According to example embodiments disclosed herein, user equipment/user device roaming may be ‘QoS-aware’ such that a user equipment may prioritize, over conventional roaming procedures or RAN nodes determined according to conventional roaming procedures, use of at least one NTN RAN network that the user equipment has been made aware, according to configuration information disclosed herein, that the NTN RAN is configured to, or is capable of, facilitating connectivity and traffic delivery according to parameter values associated with a QoS profile that corresponds to operation by the user equipment with respect to the user equipment's home network. Thus, end-to-end QoS experienced by the user equipment may not be negatively affected regardless of whether the user equipment is operating with respect to a home network or a roaming network. According to an example embodiment disclosed herein, a user equipment that is roaming may override existing roaming behavior by selecting a roaming NTN RAN node that may be configured to, or that may be capable of, providing a guaranteed QoS to the user equipment despite the NTN RAN node being determined by the user equipment to correspond to a lower coverage level/weaker signal strength than another radio network with respect to which the user equipment may be capable of roaming.

According to example embodiments disclosed herein, a non-terrestrial radio network node may effectively treat incoming roaming connection establishment requests as inter-RAN network handover (e.g., fast roaming without the need to pass through the primary/home RAN network while guaranteeing a desired/subscribed QoS associated with the roaming user equipment device). An NTN RAN may be proactively made aware of the home network with which a roaming user equipment is associated.

According to conventional techniques, roaming procedures are best effort, wherein QoS requirements are not enforced by a user equipment's home network while the user equipment is roaming in a coverage region corresponding to a visited/roaming network. Instead, according to example embodiments disclosed herein, a home RAN may enforce a determined QoS with respect to determined user equipment priority classes when the user equipment is/are operating within roaming networks according to information coordinated by, and with, the home network.

Roaming procedures according to conventional techniques are reactive such that roaming may be triggered by a roaming user equipment by selecting a first roaming network to camp on, selecting a second roaming network to camp on if the first network cannot be camped on, and so on. Instead, according to example embodiments disclosed herein, proactive roaming is enabled such that a roaming network is already aware of a guaranteed roaming QoS associated with user equipment that are not roaming, or that have yet to begin roaming, within a coverage region corresponding to the roaming network. Coordinating and making roaming networks aware of QoS priority information corresponding to the user equipment may be facilitated by radio link and backhaul link signaling procedures to deliver roaming priority information and roaming device class information.

According to conventional techniques, user equipment device roaming behavior is QoS-unaware, meaning user equipment devices may roam within coverage regions corresponding to networks that may or may not facilitate connection reliability and quality of service subscribed to by a user equipment with respect to a home network and thus, according to conventional techniques, roaming within a coverage region corresponding to a non-home network is typically a best-effort roaming experience. Instead, according to example embodiments disclosed herein, QoS-aware roaming is enabled by proactively making a user equipment aware of a roaming radio access network that may facilitate a subscribed-to connectivity and a subscribed-to guaranteed quality of service such that the user equipment may be enabled to determine to select a roaming RAN node that can facilitate the connectivity and quality of service levels.

According to conventional techniques, when receiving a connection establishment request from a roaming device, roaming networks, or nodes corresponding thereto, may determine user equipment information from a home network according to the user equipment ‘on-the-go’ and accordingly may relay traffic through the home network, which makes roaming costly and slow. The radio interface corresponding to a visited/roaming network and a delivered radio roaming quality-of-service are solely managed by the roaming network. Instead, according to example embodiments disclosed herein, high-priority roaming (e.g., roaming at a configured/subscribed-to QoS level) may be effectively treated as handover. According to example embodiments disclosed herein, a roaming NTN RAN network may maintain, support, or otherwise facilitate, a roaming experience according to a home QoS, subscribed to by the user equipment, within the roaming network. Thus, from the perspective of a user equipment, or a user thereof, there may be little or no difference in perceived QoS between operation of the user equipment with respect to the home network and roaming networks. Furthermore, roaming traffic can be handled by the roaming network without involvement, or with minimal involvement, by the home network, which, for example, may be based in, and primarily operational in, a different country than the roaming network.

### Priority-Aware Terrestrial Roaming.

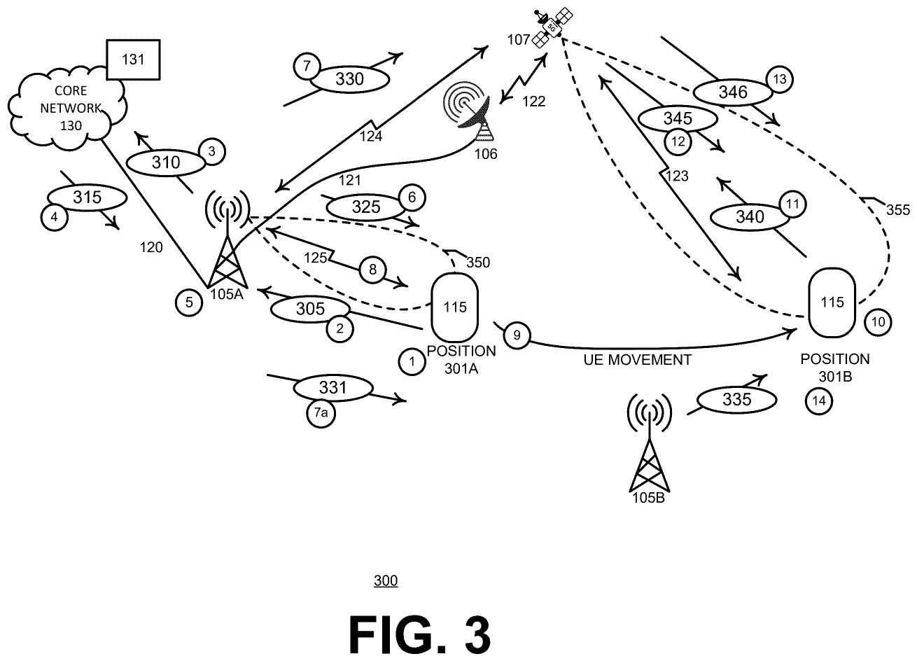

Turning now to FIG. 3, the figure illustrates an environment 300 with a user equipment 115 that may have selected TN node 105A as a serving node. RAN node 105A may be part of a home network with respect to an operator of which UE 115 may pay a subscription to use the home network. At act 1, UE 115 may determine to connect to RAN node 105A and may initiate transitioning from an idle mode to a connected mode via uplink interface link(s) 125. At act 2, UE 115 may transmit, and RAN 105A may receive, connection establishment request 305. Request 305 may comprise an identifier corresponding to UE 115 and capability information corresponding to the UE, for example, the request may comprise information indicative that UE 115 is capable of connecting with and communicating with a non-terrestrial radio network node/satellite node (e.g., NTN node 107). Based on information included in request 305, TN RAN node 105A may determine subscription and service information associated with UE 115. The subscription or service information may be indicative of a quality-of-service (“QoS”) profile, which may comprise information needed to facilitate a minimum QoS associated with UE 115 or a subscription associated therewith.

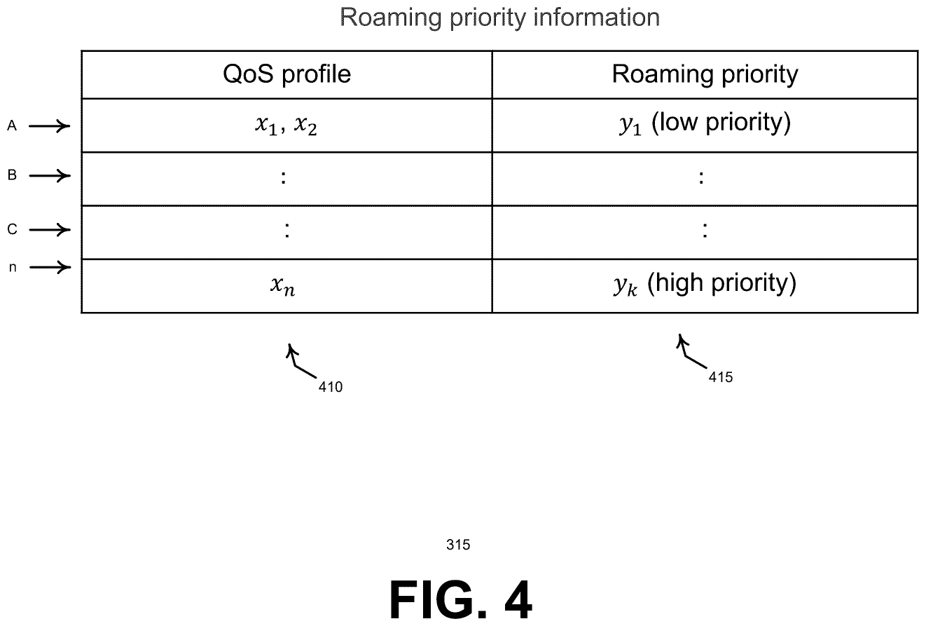

At act 3, TN RAN 105A may transmit, to an element/equipment associated with core network 130, roaming information request 310, which may comprise QoS profile information corresponding to UE 115. In response to request 310, at act 4, TN RAN node 105A may receive, from an element/equipment associated with core network 130, roaming priority information 315. Roaming priority information 315 may comprise at least one QoS profile information indication, shown in column 410 of FIG. 4, respectively associated with at least one roaming priority indication, shown in column 415, that is indicative of at least one roaming priority. Column 410 may comprise a QoS indication indicative of QoS profile information that corresponds to QoS parameter values and requirements usable to facilitate delivery of traffic with UE 115 according to a QoS corresponding to the parameters and requirements. A QoS profile indicated in column 410 may correspond to a QoS that is to be facilitated with respect to UE 115 while the UE is roaming and communicating with a node, or network corresponding thereto, other than node 105A or a network corresponding thereto. RAN node 105A may transmit request 310 in response to receiving connection establishment request 305 or RAN node 105A may transmit request 310 without being triggered by request 305 to transmit request 310.

Based on roaming priority information 315, at act 5 TN RAN node 105A may determine a device connectivity priority level indicated in column 415 based on a QoS corresponding to UE 115 indicated in column 410. In an example, a level ‘0’ may be indicative of a low connectivity priority and a higher priority of ‘n,’ which may be a highest priority value indicated in column 415, may be indicative that a UE is to be served at all times according to a QoS corresponding to a QoS indication associated with the indicated higher priority regardless of whether or not UE 115 is roaming away from a home network (e.g., a network associated with RAN node 105A) and roaming within a coverage region corresponding to a visited, or roaming network node. A roaming priority indicated in column 415 being respectively mapped to, or associated with, a minimum needed/subscribed-to QoS indicated in column 410 may facilitate determining radio resources and operations needed to facilitate delivering of traffic according to the minimum needed/subscribed-to QoS. For example, a QoS profile indication indicated in column 410 may correspond to a minimum scheduled resource pool, a maximum allowed latency budget, or a minimum guaranteed data rate, etc. Upon the determining of a roaming priority corresponding to UE 115, TN RAN node 105A may dynamically map, or associate, the roaming priority to a user equipment roaming class, with respect to which a user equipment roaming class indication may be proactively shared with a potential target/visited RAN node, for example NTN node 107, such that when UE 115 roams, for example at act 9, away from position 301A within coverage region 350 corresponding to RAN note 105A to position 301B within coverage region 355 corresponding to NTN RAN node 107, the NTN-RAN node can immediately, or with minimal delay, deliver traffic with respect to UE 115 according to a guaranteed QoS corresponding to a QoS profile associated with a user equipment roaming class indicated by UE 115 to NTN node 107 at act 11 via connection establishment request 340.

Based on determining, at act 5, a user equipment roaming priority corresponding to a quality-of-service that is to be maintained, based, for example, on a subscription, with respect to UE 115 at all times, or ubiquitously, TN RAN node 105A may determine a user equipment class identifier, or indication, corresponding to the user equipment to be usable to facilitate fast (e.g., with minimal delay) global roaming with respect to at least one visited network (e.g., a network other than a home network corresponding to RAN node 105A), which may comprise one or more NTN networks, according to a quality-of-service corresponding to the determined user equipment roaming class identifier/indication.

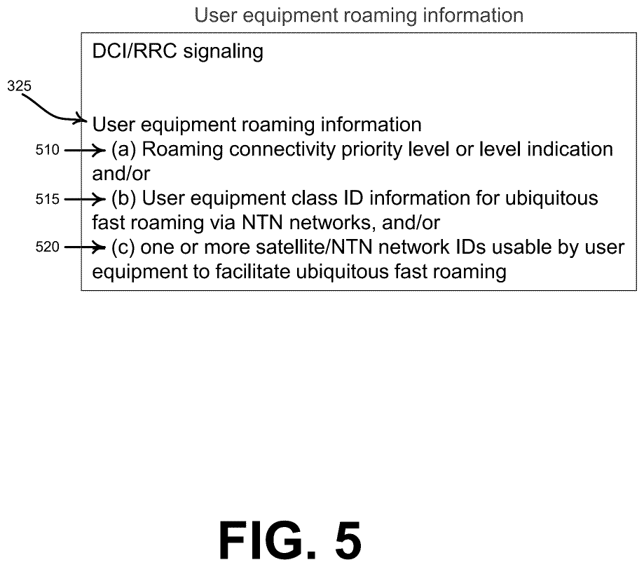

At act 6, TN RAN node 105A may generate and transmit downlink control information message 325, which may comprise information referred to as user equipment roaming information, toward user equipment 115 via downlink radio interface link(s) 125. As shown in FIG. 5, user equipment roaming information 325 may comprise at least one of: at least one user equipment roaming priority level or level indication 510; at least one device class identifier 515, or indication, to be usable to facilitate global fast roaming via visited NTN networks; or at least one satellite/NTN network identifier 520, indication, to be usable for all-time/ubiquitous fast roaming. User equipment roaming priority indication 510 may facilitate a user equipment, for example user equipment 115, determining, or identifying, whether a roaming/visited/target RAN node, for example a TN RAN node, can facilitate delivery of traffic with respect to the user equipment according to a minimum needed QoS required/subscribed to by the user equipment before the user equipment actually selects the roaming/visited/target RAN node for roaming. Determining whether a target roaming RAN node can facilitate delivering a traffic with respect to the user equipment according to a particular quality of service may be referred to as QoS-aware roaming RAN selection. A class identifier indicated in field 515 or a satellite/NTN node identifier indicated in field 520 may facilitate user equipment 115 determining a roaming network if source/home RAN node 105A has configured the user equipment with QoS-guaranteed roaming network information indicative of a roaming network that should be prioritized by the user equipment in determining a RAN node, or a network corresponding thereto, with respect to which the user equipment is to select and to which the user equipment may transmit a connection establishment request.

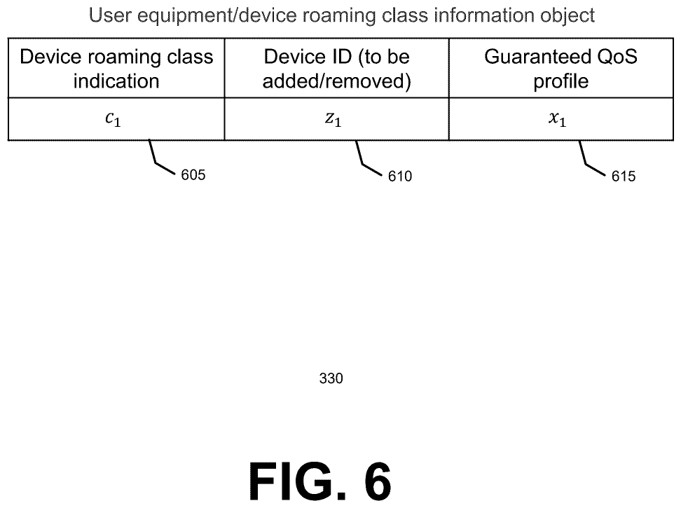

At act 7, TN RAN node 105A may compile, update, or transmit, to NTN node 107, a roaming device class information object message 330, which may comprise information that may be referred to as user equipment roaming class information 330. Information/message 330 may comprise identification information corresponding to user equipment 115 to facilitate NTN RAN node 107 delivering traffic with respect to UE 115 according to a roaming QoS guaranteed to UE 115. Roaming device class information object/message/information 330 may be transmitted to NTN RN node 107 via TN-NTN shared core network equipment/element 131 or NTN gateway 106. As shown in FIG. 6, information 330 may comprise at least one of: in field 605 at least one user equipment roaming class indication, in field 610 at least one user equipment identifier associated with the at least one user equipment roaming class indication indicated in field 605, or in field 615 at least one indication of minimum QoS profile information indicative, or corresponding to, a QoS to be accommodated by roaming/visited/target NTN network node 107 with respect to at least one user equipment indicated in field 610.

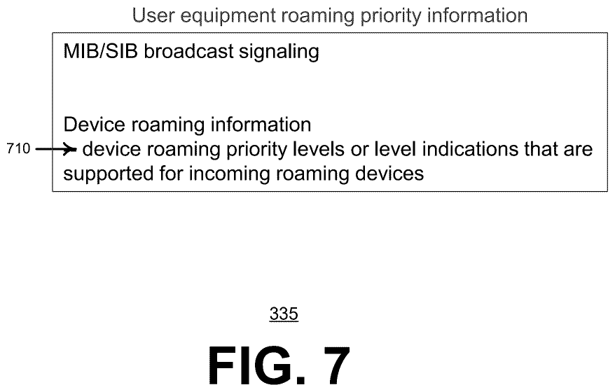

In an example embodiment, a TN RAN node 105, for example TN RAN node 105B shown in FIG. 3, may, as shown by FIG. 7, based on determining real-time metrics corresponding to resource utilization state parameters, determine, and broadcast as part of master information block (“MIB”) signal message(s) or system information block (“SIB”) signal message(s), user equipment roaming priority information 335 that may comprise at least one user equipment priority level indication 710 indicative of at least one roaming priority level that is ubiquitously/all-time supported by TN-RAN 105B. Information 335 may be usable by user equipment 115 to determine to establish a connection with TN RAN node 105B when the user equipment is roaming within a coverage region corresponding to the TN RAN node, if roaming connection with a non-terrestrial node, for example in TN RAN node 107, failed to be established in response to the user equipment transmitting to the NTN node a connection establishment request, for example connection establishment request 340. TN RAN node 105B may receive information to broadcast, via an MIB or SIB signal message, via a message 331 as shown at act 7a in FIG. 3. A message 331 may comprise similar information as a message 330.

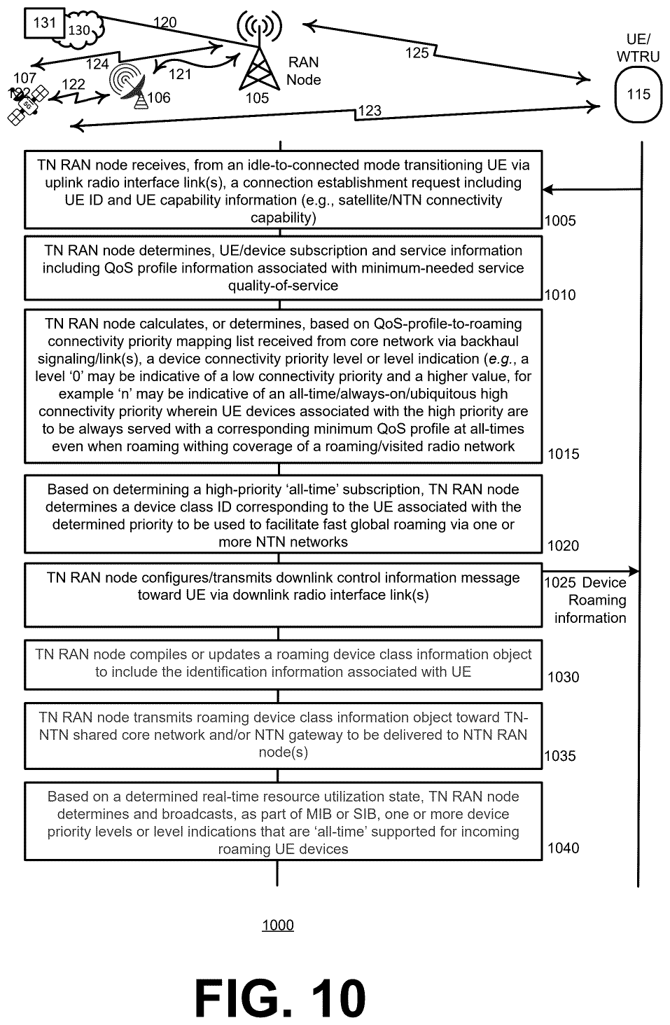

Turning now to FIG. 10, the figure illustrates a timing diagram of an example method 1000. At act 1005, terrestrial network RAN node 105 may receive, from UE 115, which may be transitioning from an idle mode to a connected mode, via uplink radio interface link(s) 125, a connection establishment request, for example request 305 shown in FIG. 3. Request 305 may comprise a user equipment identifier associated with UE 115 and capability information corresponding to UE 115 that may indicate capability of the UE to connect to and communicate with, or via, satellite/NTN node 107. At act 1010, TN RAN node 105 may determine device subscription and service information, corresponding to user equipment 115, that may comprise an indication of a minimum quality-of-service profile required by, or subscribed to with respect to, UE 115. At act 1015, TN RAN node 105 may calculate, or otherwise determine, based on roaming priority information 315 received from core network via backhaul signaling link(s), a device connectivity priority level, or level indication, corresponding to UE 115. For example, as shown in FIG. 4, a determined priority ‘0’ may correspond to a low connectivity priority shown in field 415A or a high connectivity priority (e.g., shown in field 415n) may be associated with a high QoS, or at least a guaranteed QoS that is to be always, or ubiquitously, available to UE 115 regardless of whether UE 115 is being served by home RAN node 105 or a roaming RAN node associated with a visited/non-home radio network.

Based on a high-priority, all-time/ubiquitous device subscription, corresponding to UE 115 and a session being facilitated via the connection established in response to the request received at act 1005, at act 1020 TN RAN node may determine a user equipment roaming class, and a user equipment roaming class indication indicative thereof to facilitate fast, global roaming with respect to at least one NTN network or at least one NTN node 107 corresponding thereto. At act 1025, TN RAN node may configure/transmit to UE 115 user equipment roaming information message 325, described in reference to FIGS. 3 and 4. Message 325 may be transmitted via a downlink control information toward UE 115 via downlink radio interface link(s). Information 325 may comprise at least one of: at least one device connectivity priority level or level indication 510; at least one device class identifier 515 to be usable by UE 115 to facilitate global fast roaming at least one NTN network; or at least one satellite/NTN network node identifier 520 that may be usable by UE 115 to determine an NTN node, with which to request connection establishment while UE 115 is roaming, that may be capable of facilitating a quality-of-service corresponding to the priority determined at act 1015. At act 1030, TN-RAN node may compile and/or update a roaming device class information object 330, which may be referred to as user equipment roaming class information and which may comprise the device class identifier 515 determined at act 1025, a device identifier associated with UE 115, or quality-of-service profile information that is indicative of a quality-of-service to be facilitated by NTN node 107 with respect to UE 115 while UE 115 is roaming away from home TN RAN node 105 and roaming within a signal-coverage-region corresponding to NTN-node 107. At act 1035, TN RAN node 105 may transmit roaming device class information object 330 toward TN-NTN shared core network. Information object/message 330 may be delivered to NTN node 107 via NTN gateway 106 or shared entity 131.

In an embodiment, acting as a roaming RAN with respect to a user equipment for which a network to which TN RAN node 105 corresponds is not a home network, at act 1040 TN RAN node 105 may broadcast, as part of a master information block signal or a system information block signal, at least one device priority level indication 335 to be indicative to user equipment that are roaming with a signal coverage region corresponding to TN-RAN node 105 of at least one priority that RAN node 105 may facilitate on an all-time, or ubiquitous, basis. RAN node 105 may determine to broadcast a priority level indication message 335 based on a determination being made that a resource utilization state criterion (e.g., a capacity criterion, an energy usage criterion, or a network energy saving criterion being satisfied at RAN node 105).

### Fast Device Roaming Switching.

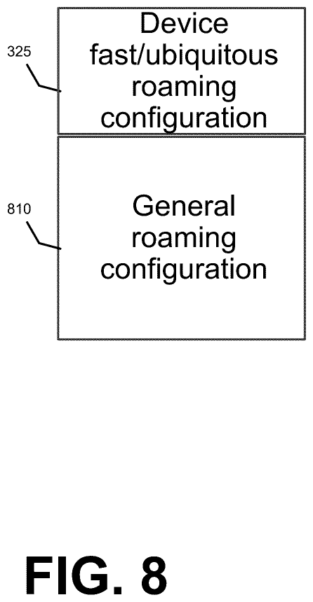

Returning to description of FIG. 3, as described above, non-terrestrial network capable UE/WTRU 115 may transmit connection establishment request 305 to TN RAN node 105A and receive therefrom via downlink radio interface link(s) 125, user equipment roaming information 325 described in reference to FIG. 5. As shown by FIG. 8, based on receiving fast roaming configuration information (e.g., user equipment roaming information 325), UE 115 may overriding previously-configured/default roaming priority 810, which may comprise a TN RAN network list, by placing received NTN RAN network identifiers indicated in field 520 of information 325, in a highest priority, or a superior priority with respect to previously-configured roaming information, to facilitate fast (e.g., minimal delay in establishing a roaming connection) QoS-guaranteed roaming with NTN node 107. Such prioritizing of NTN RAN nodes above, or ahead of, TN RAN nodes for purposes of determining a roaming node with which to establish connection is novel at least insofar as different networks potentially available for roaming by UE 115 may be treated differently. For example, UE 115 may be configured, via information 325, to prioritize attempting to roam with respect to NTN node 107 ahead of attempting to roam with respect to TN node 105B if information 325 is indicative that NTN node 107 is capable of, or is configured to, facilitate a connection with UE 115 that can accommodate delivery of traffic according to a QoS that is guaranteed to UE 115 when the UE is roaming with a visited network.

As shown in FIG. 3, based on UE/WTRU 115 not detecting at least one RAN node associated with a primary/home RAN network (e.g., a non-roaming RAN network) due to, for example, having moved from position 301A to position 301B, at act 10 roaming UE/WTRU 115 may search for and select/reselect an NTN RAN node 107 configured, via information 330, to accommodate a priority corresponding to a user equipment roaming priority corresponding to UE 115, as indicated to the UE via information 325, which selected/reselected NTN RAN node the UE may have prioritized with respect to previously-configured/default information 810 as shown in FIG. 8. UE 115 may select/reselect NTN node 107 regardless of whether the UE detects at least one non-high-priority TN RAN node (e.g., a TN node that has not been configured to accommodate traffic delivery according to a roaming QoS priority guaranteed to the UE) that may be capable of facilitating roaming with respect to UE 115, even if the at least one other TN-RAN node may be determined by UE 115 to correspond to a stronger signal strength than a NTN RAN node 107 that has been configured to facilitate high-priority QoS-guaranteed roaming with respect to UE 115.

Based on an application layer corresponding to UE 115 triggering initiation of an active communication session, UE/WTRU 115 may transmit, at act 11 to NTN node 107, uplink connection establishment request 340. Request 340 may comprise in field 910 at least one user equipment/device class identifier (e.g., an identifier indicated in field 515 of information 325), in addition to conventional user equipment/device identification information, and user equipment/device capability information that may be indicated in field 915. For example, a roaming device class indicated in field 515 of information 325 may be used by UE 115 to indicate to NTN node 107, via request 340, a roaming device class corresponding to UE 115 to facilitate the NTN node rapidly (e.g., before or during RRC connection establishment) fetching QoS information, associated with the device class, that is to be maintained/supported/accommodated/facilitated with respect to UE 115 such that a quality-of-service associated with a communication session established by UE 115 with RAN node 105A based on connection establishment message 305 may be continued via a session established based on connection establishment message 340 transmitted by UE 115 after the UE roams away from RAN node 105A and into a signal coverage region corresponding to NTN node 107. At act 12, UE/WTRU 115 may receive from NTN node 107 NTN roaming connection establishment setup information 345 that may correspond to the guaranteed minimum QoS profile information indicated via message 340. UE 115 and NTN node 117 may establish a roaming connection based on the transmitting of roaming connection establishment request 340 and roaming connection establishment setup information 345 and delivery of traffic via the roaming connection may be accommodated according to a quality-of-service corresponding to roaming device class indication/information indicated in field 910 of the roaming connection establishment request.

If UE/WTRU 115 fails to establish a roaming connection with NTN node 107 that can facilitate a QoS corresponding to a priority level indicated in field 510 of information 325, WTRU 115 may detect and decode information broadcast by at least one TN RAN node other than home TN RAN node (e.g., TN RAN node 105B) to facilitate roaming according to the QoS associated with the priority level indicated in field 510 or according to conventional best-effort roaming if the QoS associated with the priority level corresponding to the user equipment roaming session is not available from, or supported, by roaming TN RAN node 105B. Based on detecting a broadcast message, for example a MIB signal message or a SIB signal message, broadcast by TN RAN node (e.g., node 105B) other than home TN node 105A, that is indicative of a device roaming priority level that is equal to or higher than a roaming priority corresponding to UE 115 configured via information 325, UE/WTRU 115 may prioritize a RAN network corresponding to the other TN RAN node 105B for roaming and may transmit an uplink connection establishment request to TN RAN node 105B via uplink radio interface link(s) 125. Thus, based on a user equipment roaming priority configured via field 510 in information 325, user equipment 115 may prioritize available roaming RAN nodes that have broadcast an indication of available roaming support for quality of service corresponding to a device priority equal to or greater than the device-specific roaming priority indicated via field 510 and corresponding to UE 115.

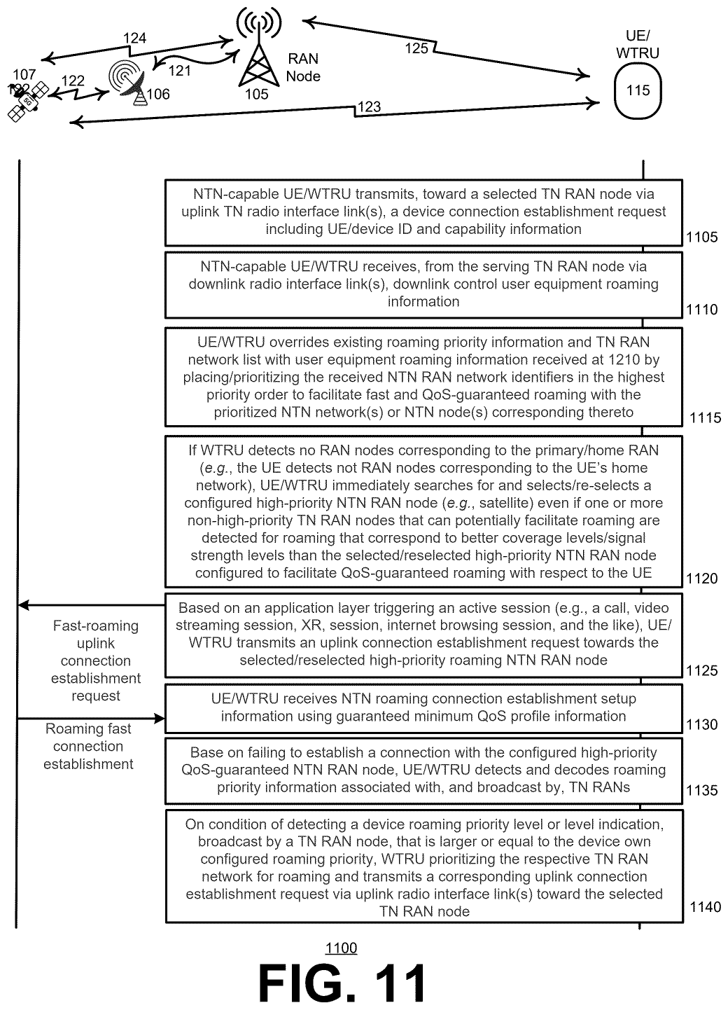

Turning now to FIG. 11, the figure illustrates a timing diagram of an embodiment method 1100. At act 1105, non-terrestrial network capable UE/WTRU 115 may transmit, toward selected terrestrial RAN node 105 via uplink terrestrial radio interface link(s) 125, a device connection establishment request that may comprise at least one user equipment identifier corresponding to UE 115 or capability information corresponding to UE 115 (e.g., the capability information may comprise capability information indicative that UE 115 is capable of connecting to, or communicating with, a non-terrestrial network node/satellite). At act 1110, NTN-capable UE/WTRU 115 may receive, from serving TN RAN node 105 via downlink radio interface link(s), downlink control information, such as user equipment roaming information 325, that may comprise: at least one device connectivity priority level or level indication corresponding to UE 115; at least one user equipment roaming claim indication usable by UE 115 to indicate, and to facilitate, global fast roaming with respect to NTN networks; or at least one satellite/NTN network identifier, for example an identifier associated with NTN node 107, indicative of an NTN node that can facilitate ubiquitous/all-time/always-on fast roaming according to a quality of service corresponding to UE 115. At act 1115, based on receiving fast roaming configuration information (e.g., user equipment roaming information 325), UE/WTRU 115 may override existing roaming priority information in a TN RAN network list by placing NTN RAN network identifiers indicated by information 325 in a high priority order (as shown in FIG. 8) to facilitate fast and QoS-guaranteed roaming with a roaming network node. At act 1120, based on UE/WTRU detecting no RAN nodes corresponding to a primary/home network of UE 115 (e.g., not detecting a reference signal corresponding to a non-roaming RAN network corresponding to RAN node 105), UE/WTRU 115 may search for and select/reselect a high-priority NTN RAN node (e.g., satellite node 107) configured via information 325, and prioritized at act 1115, regardless of detecting at least one TN RAN node other than node 105 that has indicated that the other TN RAN node does not support roaming according to a QoS corresponding to a roaming priority indicated by field 325, even if the other TN RAN node(s) may be determined by UE 115 to correspond to better coverage levels (e.g., stronger signal strength) than an NTN node indicated by field 520 of information 325. At act 1125, based on an application layer of UE 115 triggering an active communication session (e.g., a call, a video streaming session, and the like), the UE may transmit an uplink connection establishment request 340 toward configured high-priority roaming NTN RAN node 107. Connection establishment request 340 may comprise at least one user equipment roaming class indication as well as identifier and capability information corresponding to user equipment 115. At act 1130, UE/WTRU 115 may receive NTN roaming connection establishment setup information 345 indicative of a connection to be set up between NTN node 107 and UE 115 according to a guaranteed minimum QoS indicated by QoS profile information associated, in user equipment roaming class information (e.g., information 330) indicated to NTN node 107, with a user equipment roaming class identifier indicated by UE 115 to NTN node 107 via connection establishment request transmitted at act 1125. At act 1135, based on UE/WTRU 115 failing to establish a connection with a high-priority QoS-guaranteed NTN RAN configured via field 520 in information 325 received at act 1110, the UE/WTRU may detect and decode information broadcast from TN RAN nodes, other than home node 105, according to a configured roaming priority to facilitate roaming, which may be best-effort roaming. At act 1140, based on detecting a user equipment roaming priority level indication being broadcast by a TN node, other than node 105, via a MIB or SIB signal message, that is indicative of a roaming priority that is equal to or larger than a roaming priority configured via field 510 in information 325 received at act 1110, UE/WTRU 115 may prioritize a TN RAN network, corresponding to the roaming priority that is equal to or larger than the roaming priority configured via field 510 in information 325, for roaming, may select a TN RN node corresponding to the prioritized TN RAN network, and may transmit a corresponding uplink connection establishment request via uplink radio interface link(s) towards the selected TN RAN node.

Proactive Non-Terrestrial Roaming for all-Time Connectivity Services.

Returning to description of FIG. 3, at act 7, non-terrestrial network RAN node 107 may receive user equipment roaming information 330 directed to the NTN node by home TN RAN node 105A. Information 330 may comprise user equipment roaming class information corresponding to UE 115, for example, information 330 may comprise in field 605, shown in FIG. 6, at least one user equipment roaming class indication indicative of at least user equipment roaming priority corresponding to at least one user equipment indicted in field 610. Information 330 may comprise in field 615 at least one quality-of-service profile information indication indicative of at least one quality-of-service profile and resources corresponding thereto that may facilitate delivery of traffic with respect to UE 115 according to a quality-of-service corresponding to the at least one quality-of-service profile information indication indicated in field 615. A QoS profile indicated by field 615 may correspond to a minimum QoS to be maintained via roaming NTN network node 107 with respect to delivering traffic with respect to UE 115 indicated in field 610. Information 330 may be directed to NTN node 107 by TN node 105 via ground shared core network element 131 and/or NTN gateway 106 via backhaul interface link(s). Receiving of information message 330 before receiving connection establishment request 340 may facilitate NTN RAN node 107 proactively being made aware of potential incoming roaming device connection establishment request message(s) that may require a certain, or determined, minimum QoS. NTN RAN node 107 may receive an uplink connection establishment request message 340 from roaming user equipment 115. In an example embodiment, NTN RAN node 107 may search for a device identifier, indicated by request 340, within at least one user equipment identified via field 610 in message 330 indicated to NTN node 107 by TN node 105, and based thereon may determine a roaming device class indicted in field 605 that is associated with the user equipment, or roaming class, indicted by request 340. In an example embodiment, NTN RAN node 107 may determine a quality-of-service with respect to which traffic delivery is to be accommodated with respect to a user equipment based on a roaming class indicated in field 910 of request 340.

Based on determining a user equipment roaming class indicated by information in request 340 that may be associated with a user equipment (e.g., UE 115) identified in request 340, NTN RAN node 107 may fetch, or determine, a minimum roaming quality-of-service profile corresponding to the determined roaming device class. In an embodiment, the minimum quality-of-service profile may be indicated by field 615 in information 330. NTN RAN node 107 may accept connection establishment request 340 and may locally allocate at least one NTN radio bearer that matches, or that can accommodate, the determined minimum QoS profile, corresponding to a device class indicated in field 605 that is associated in message 330 with a user equipment identifier indicated in field 915, or a roaming class indicated in field 910, of request 340. If UE 115 and NTN node 107 fail to establish a connection via at least one radio bearer determined to be capable of facilitating delivery of traffic to UE 115 according to a quality-of-service indicated in message 330 that corresponds to a roaming class indicated in field 910, NTN RAN node 107 may transmit, toward UE 115, as a downlink control information message, a QoS-guaranteed roaming failure indication 346. After receiving failure indication 346, UE 115 may attempt to connect with another RAN node, for example TN RAN node 105B shown in FIG. 3, to facilitate delivery of traffic, which delivery may or may not be facilitated according to a QoS associated with a QoS profile indicated by field 615 of connection establishment request 340.

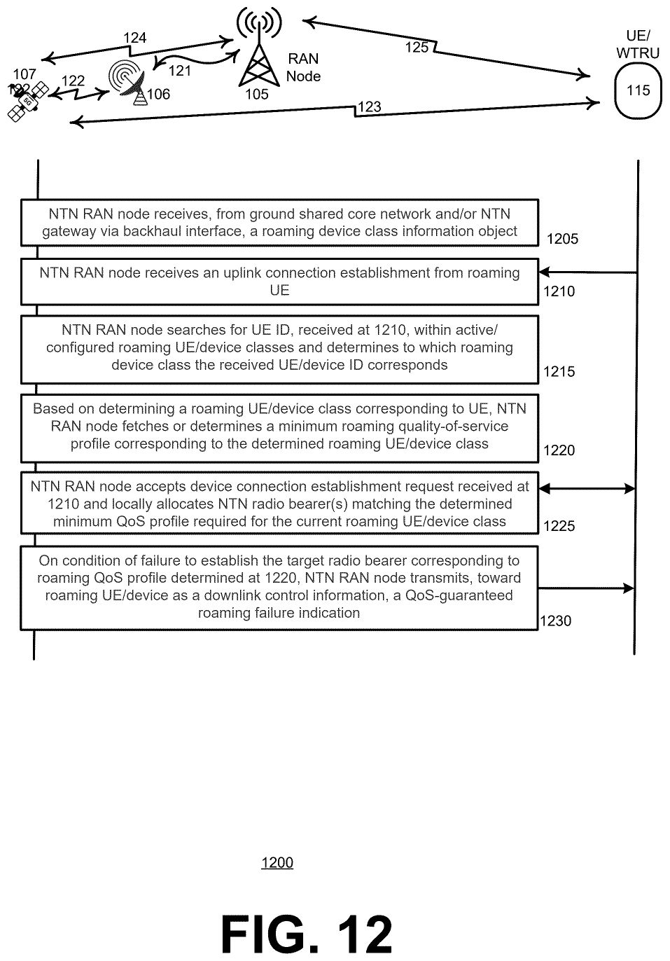

Turning now to FIG. 12, the figure illustrates a timing diagram of an example method embodiment 1200. At act 1205, non-terrestrial network RAN node 107 may receive, from a terrestrial shared core network equipment element or an NTN gateway via backhaul interface link(s), a user equipment roaming device class information object (e.g., information 330 shown in FIG. 6), that may comprise at least one of: at least one user equipment roaming class indication; at least one user equipment identifier/indication associated with the at least one user equipment roaming class indication; or at least one minimum QoS profile indication indicative of a QoS to be accommodated with respect to UE 115 when roaming within a signal strength coverage region corresponding to NTN node 107. At act 1210, NTN RAN node 107 may receive an uplink connection establishment from a roaming user equipment device (e.g., UE 115). In an embodiment, at act 1215, NTN RAN node 107 may search for, or look up, a user equipment identifier, indicated by information received in the connection establishment request received at act 1210, in information received at act 1205 (e.g., information 330) to determine a user equipment roaming device class associated with the user equipment indicated by the connection request received at act 1210. At act 1220, based on determining a roaming device class corresponding to a user equipment indicated in the connection establishment request received ag act 1210, NTN RAN node 107 may fetch and determine a minimum roaming quality-of-service profile corresponding to the roaming device class determined at act 1215. At act 1225, NTN RAN node 107 may accept the device connection establishment request received at act 1210 and may locally allocate NTN radio bearers that match, or that are capable of accommodating, a QoS corresponding to the minimum QoS profile determined at act 1220. At act 1230, on condition of failure to establish the target radio bearer corresponding to the roaming QoS profile determined at act 1220, NTN RAN node 107 may transmit, toward intended roaming user equipment 115, as a downlink control information, a QoS-guaranteed roaming failure indication (e.g., indication 346 shown in FIG. 3).

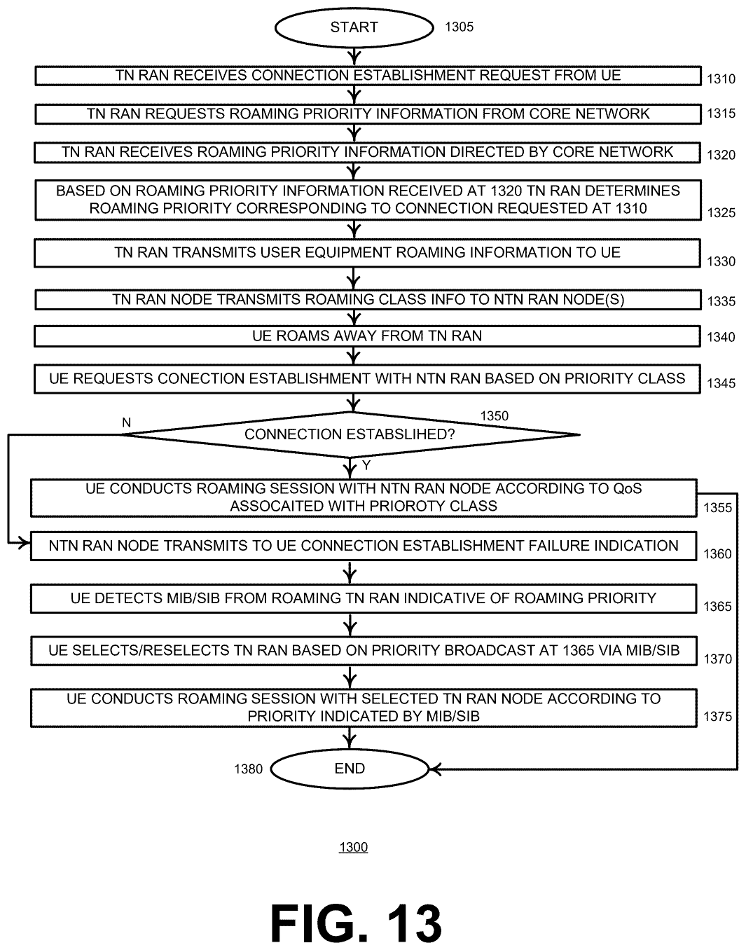

Turning now to FIG. 13, the figure illustrates a flow diagram of an example method 1300. Method 1300 begins at act 1305. At act 1310, a terrestrial radio network node may receive a connection establishment request from a user equipment, for example request 305 described in reference to FIG. 3. The terrestrial radio network node may be associated with, may correspond to, or may be part of a home network with respect to the user equipment. At act 1315, the terrestrial radio network node may transmit a request to request, from network equipment associated with a core network, roaming priority information. Responsive to the request transmitted at act 1310, at act 1320, the terrestrial radio network node may receive, from network equipment associated with a core network, roaming priority information directed by core network equipment to the terrestrial radio network node.

At act 1325, based on roaming priority information received at act 1320, the terrestrial radio network node may determine a roaming priority corresponding to a connection that may have been request by, or established in response to, the request received at act 1310. A roaming priority determined at act 1325 may be associated with a quality-of-service corresponding to the connection that may have been established in response to the request received at act 1310. The roaming priority determined at act 1325 may be associated with the quality-of-service in the roaming priority information received at act 1320. At act 1330, the terrestrial radio network node may transmit, to the user equipment that transmitted the request received at act 1310, user equipment roaming information indicative of information corresponding to the priority determined at act 1325. The user equipment roaming information transmitted to the user equipment at act 1330 may comprise a roaming priority indication or a roaming priority class indication, either of which may be associated with the quality of service corresponding to a connection that may have been requested by, or established in response to, a request received at act 1310. The user equipment roaming information transmitted to the user equipment at act 1330 may comprise at least one non-terrestrial radio network node identifier associated with at least one roaming non-terrestrial radio network node (e.g., a roaming non-terrestrial radio network node that is not part of a home network that corresponds to the user equipment that transmitted the connection establishment request that was received at act 1310). The at least one roaming non-terrestrial radio network node indicated by the user equipment roaming information may be configured to, or may be capable of, facilitating delivery of traffic with respect to the user equipment from which the connection establishment request was received at 1310 according to a quality-of-service corresponding to a subscription associated with the user equipment or at least a quality-of-service corresponding to a connection that may have been requested by, or established in response to, the connection establishment request received at act 1310. At act 1335, the terrestrial radio network node may transmit roaming class information to at least one non-terrestrial radio network node that may have been indicated by the user equipment roaming information transmitted to the user equipment at act 1330.

At act 1340, the user equipment may roam away from the home terrestrial radio network node such that the user equipment does not have connectivity capability with a radio network node corresponding to the home network corresponding to the user equipment. (E.g., UE 115 moves from position 310A to position 301B as shown in FIG. 3.) To facilitate connection and delivery of traffic that may correspond to a quality-of-service associated with a connection that may correspond to, that may have been requested by, or that may be established in response to the request received at act 1310, at act 1345, the user equipment may transmit a connection establishment request to a non-terrestrial radio network node indicated in the user equipment roaming information transmitted to the user equipment at act 1330. In response to receiving the connection establishment request transmitted by the user equipment at act 1345, the non-terrestrial radio network node may attempt to set up, or establish, at least one radio bearer to facilitate delivery of traffic with respect to the user equipment according to a quality of service corresponding to a priority class indication that may have been indicated in the connection establishment request transmitted by the user equipment to the non-terrestrial radio network node at act 1345.

At act 1350, a determination may be made by the non-terrestrial radio network node whether a connection has been established, or may be capable of being established, with the user equipment that transmitted the connection establishment requested at act 1345 according to a quality-of-service corresponding to a priority class indicated by the connection establishment request transmitted at act 1345. If a determination is made at 1350 that a connection has been established, or is capable of being established, with respect to the user equipment according to the quality-of-service corresponding to the priority class indicated by the connection establishment request transmitted at act 1345, at act 1355 the non-terrestrial radio network node and user equipment may conduct a roaming communication session according to the quality-of-service corresponding to the priority class indicated in the connection establishment request transmitted by the user equipment to the non-terrestrial radio network node at act 1345. Method 1300 advances from act 1355 to act 1380 and ends.

Returning to description of act 1350, if a determination is made that a connection has not been established, or may not be capable of being established, with the user equipment that transmitted the connection establishment requested act 1345 according to a quality-of-service corresponding to a priority class indicated by the connection establishment request transmitted at act 1345, method 1300 may advance to act 1360. At act 1360, the non-terrestrial radio network node may transmit to the user equipment a connection establishment failure indication. After receiving a connection establishment failure indication from the non-terrestrial radio network node, the user equipment may monitor, ‘listen’ for, or detect roaming priority information broadcast by a terrestrial radio network node that is not part of the home radio network corresponding to the user equipment. The roaming priority indication corresponding to at least one terrestrial radio network node may be broadcast by the at least one terrestrial radio network node via at least one MIB or SIB signal message. At act 1370, the user equipment may select, or reselect, one of the at least one non-home, or roaming, terrestrial radio network node according to the at least one roaming priority indicated by the at least one roaming terrestrial radio network node via the at least one MIB or SIB signal message. The user equipment may select the roaming terrestrial radio network node based on a roaming priority indicated by the at least one roaming terrestrial radio network node that is equal to or higher than a priority indicated to the user equipment at act 1330. A roaming priority indicated to the user equipment at act 1330 may correspond to a connection that may have been established in response to the connection establishment request received by the home terrestrial radio network node at act 1310. In an embodiment, even if the user equipment does not detect from at least one roaming terrestrial radio network node an indication of a roaming priority that equals or exceeds a roaming priority indicated to the user equipment at act 1330, the user equipment may select a roaming terrestrial radio network note that may broadcast a roaming priority indication indicative of a roaming priority that that may be a highest priority indicated by all roaming terrestrial radio network nodes with respect to which the user equipment may determine may provide sufficient radio signal strength coverage to the user equipment to facilitate a communication session. At act 1375, the user equipment may conduct a roaming communication session with a roaming terrestrial radio network node selected at act 1370 according to a quality-of-service associated with the roaming priority used by the user equipment at act 1370 to determine to select the roaming terrestrial radio network node. Method 1300 may advance from act 1375 to act 1380 and end.

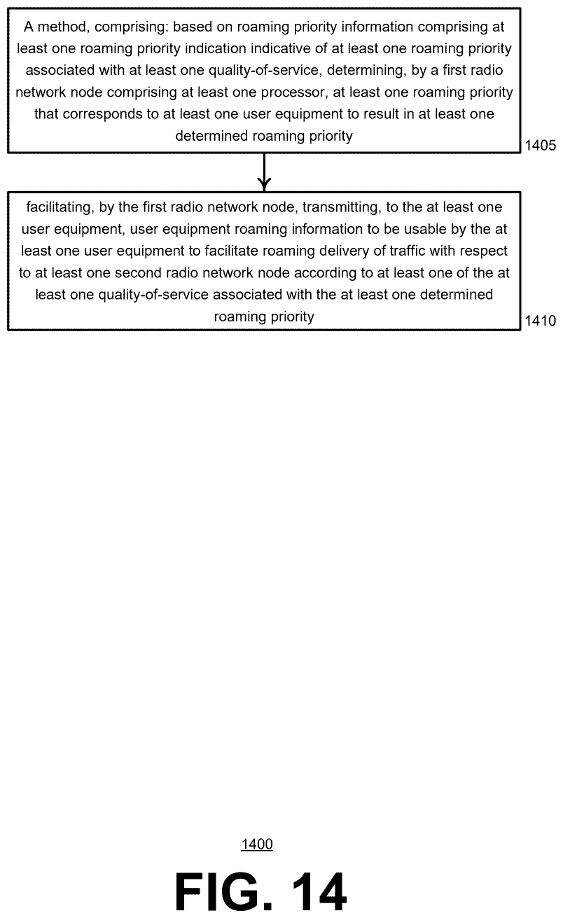

Turning now to FIG. 14, the figure illustrates an example embodiment method 1400 comprising at block 1405, based on roaming priority information comprising at least one roaming priority indication indicative of at least one roaming priority associated with at least one quality-of-service, determining, by a first radio network node comprising at least one processor, at least one roaming priority that corresponds to at least one user equipment to result in at least one determined roaming priority; and at block 1410 facilitating, by the first radio network node, transmitting, to the at least one user equipment, user equipment roaming information to be usable by the at least one user equipment to facilitate roaming delivery of traffic with respect to at least one second radio network node according to at least one of the at least one quality-of-service associated with the at least one determined roaming priority.

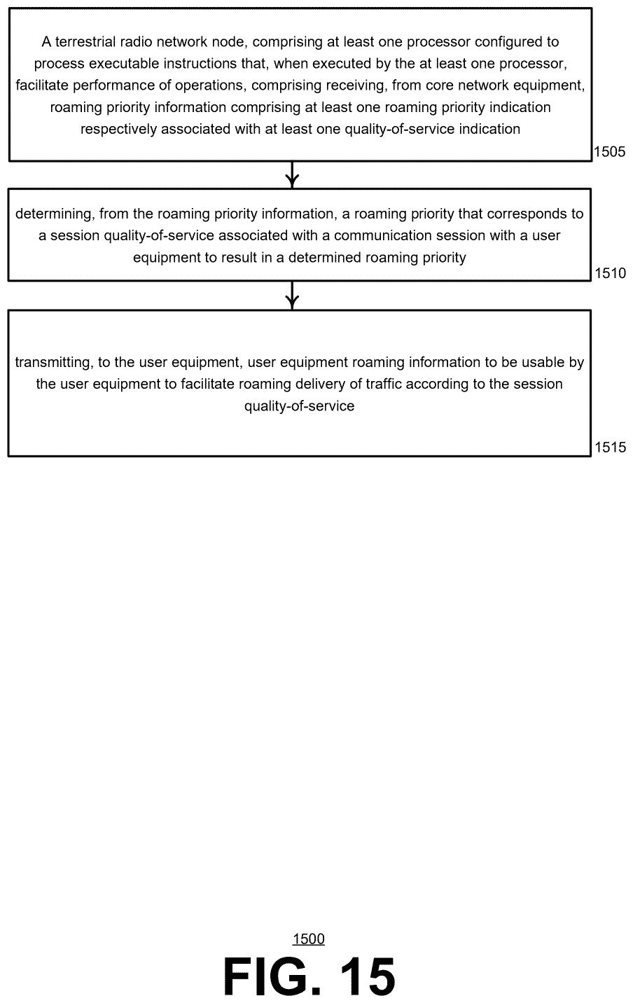

Turning now to FIG. 15, the figure illustrates a terrestrial radio network node 1500, comprising at block 1505 at least one processor configured to process executable instructions that, when executed by the at least one processor, facilitate performance of operations, comprising receiving, from core network equipment, roaming priority information comprising at least one roaming priority indication respectively associated with at least one quality-of-service indication; a block 1510 determining, from the roaming priority information, a roaming priority that corresponds to a session quality-of-service associated with a communication session with a user equipment to result in a determined roaming priority; and at block 1515 transmitting, to the user equipment, user equipment roaming information to be usable by the user equipment to facilitate roaming delivery of traffic according to the session quality-of-service.

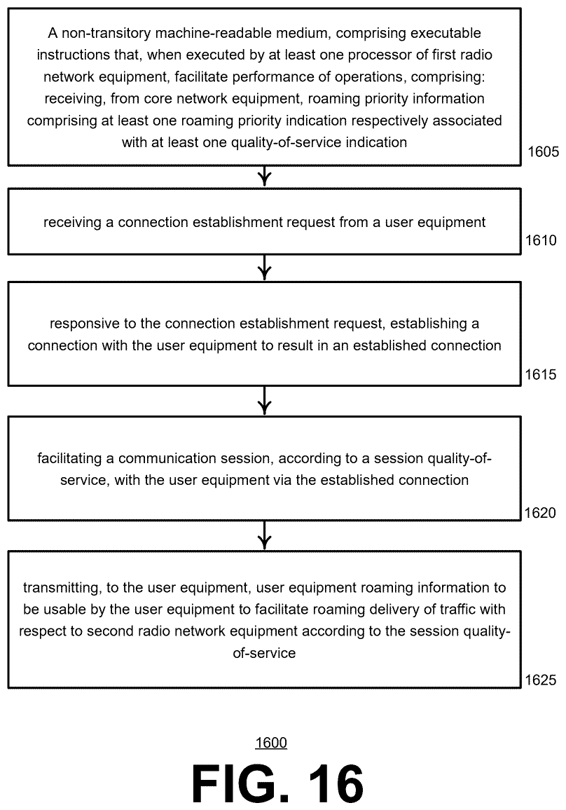

Turning now to FIG. 16 the figure illustrates a non-transitory machine-readable medium 1600 comprising at block 1605 executable instructions that, when executed by at least one processor of a terrestrial radio network node, facilitate performance of operations, comprising receiving, from core network equipment, roaming priority information comprising at least one roaming priority indication respectively associated with at least one quality-of-service indication; at block 1610 receiving a connection establishment request from a user equipment; at block 1610 receiving a connection establishment request from a user equipment; at block 1615, responsive to the connection establishment request, establishing a connection with the user equipment to result in an established connection; at block 1620 facilitating a communication session, according to a session quality-of-service, with the user equipment via the established connection; and at block 1625 transmitting, to the user equipment, user equipment roaming information to be usable by the user equipment to facilitate roaming delivery of traffic with respect to second radio network equipment according to the session quality-of-service.

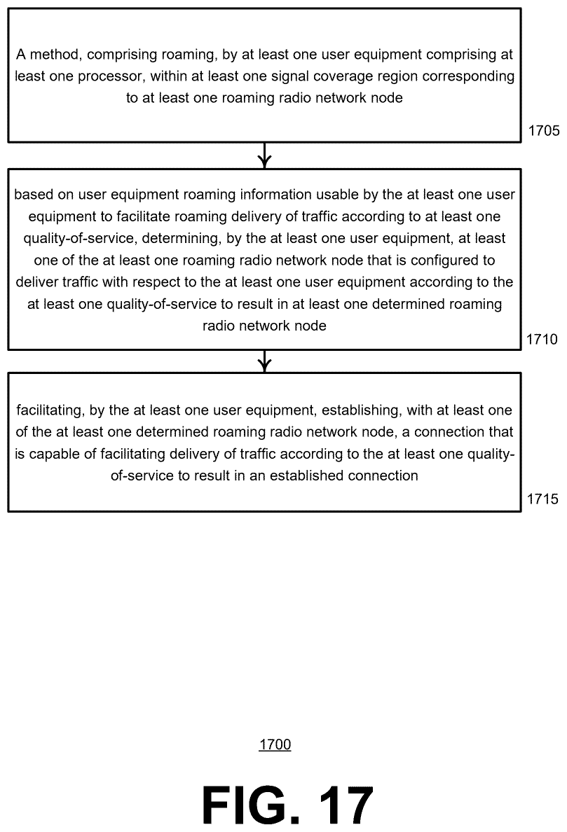

Turning now to FIG. 17, the figure illustrates an example embodiment method 1700 comprising, at block 1705, roaming, by at least one user equipment comprising at least one processor, within at least one signal coverage region corresponding to at least one roaming radio network node; at block 1710, based on user equipment roaming information usable by the at least one user equipment to facilitate roaming delivery of traffic according to at least one quality-of-service, determining, by the at least one user equipment, at least one of the at least one roaming radio network node that is configured to deliver traffic with respect to the at least one user equipment according to the at least one quality-of-service to result in at least one determined roaming radio network node; and at block 1715 facilitating, by the at least one user equipment, establishing, with at least one of the at least one determined roaming radio network node, a connection that is capable of facilitating delivery of traffic according to the at least one quality-of-service to result in an established connection.

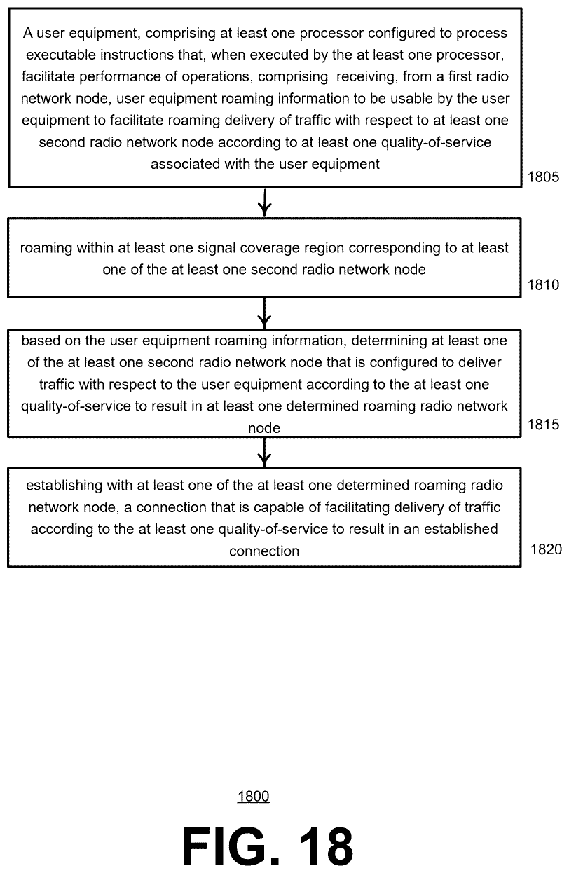

Turning now to FIG. 18, the figure illustrates an example user equipment 1800, comprising at block 1805 at least one processor configured to process executable instructions that, when executed by the at least one processor, facilitate performance of operations comprising receiving, from a first radio network node, user equipment roaming information to be usable by the user equipment to facilitate roaming delivery of traffic with respect to at least one second radio network node according to at least one quality-of-service associated with the user equipment; at block 1810 roaming within at least one signal coverage region corresponding to at least one of the at least one second radio network node; at block 1815, based on the user equipment roaming information, determining at least one of the at least one second radio network node that is configured to deliver traffic with respect to the user equipment according to the at least one quality-of-service to result in at least one determined roaming radio network node; and at block 1820 establishing with at least one of the at least one determined roaming radio network node, a connection that is capable of facilitating delivery of traffic according to the at least one quality-of-service to result in an established connection.

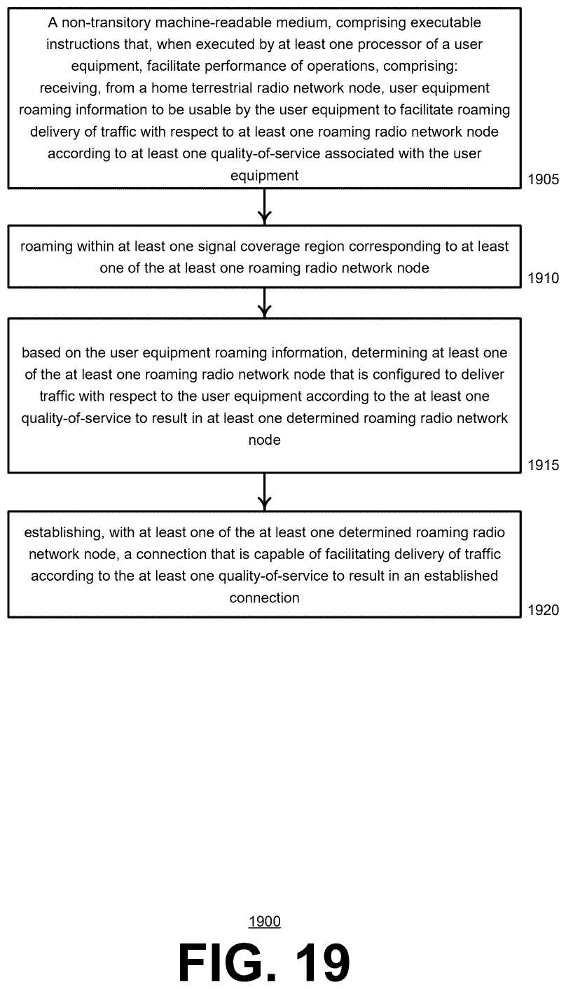

Turning now to FIG. 19, the figure illustrates a non-transitory machine-readable medium 1900 comprising at block 1905 executable instructions that, when executed by at least one processor of a non-terrestrial radio network node, facilitate performance of operations, comprising receiving, from a home terrestrial radio network node, user equipment roaming information to be usable by the user equipment to facilitate roaming delivery of traffic with respect to at least one roaming radio network node according to at least one quality-of-service associated with the user equipment; at block 1910 roaming within at least one signal coverage region corresponding to at least one of the at least one roaming radio network node; at block 1915 based on the user equipment roaming information, determining at least one of the at least one roaming radio network node that is configured to deliver traffic with respect to the user equipment according to the at least one quality-of-service to result in at least one determined roaming radio network node; and at block 1920 establishing, with at least one of the at least one determined roaming radio network node, a connection that is capable of facilitating delivery of traffic according to the at least one quality-of-service to result in an established connection.

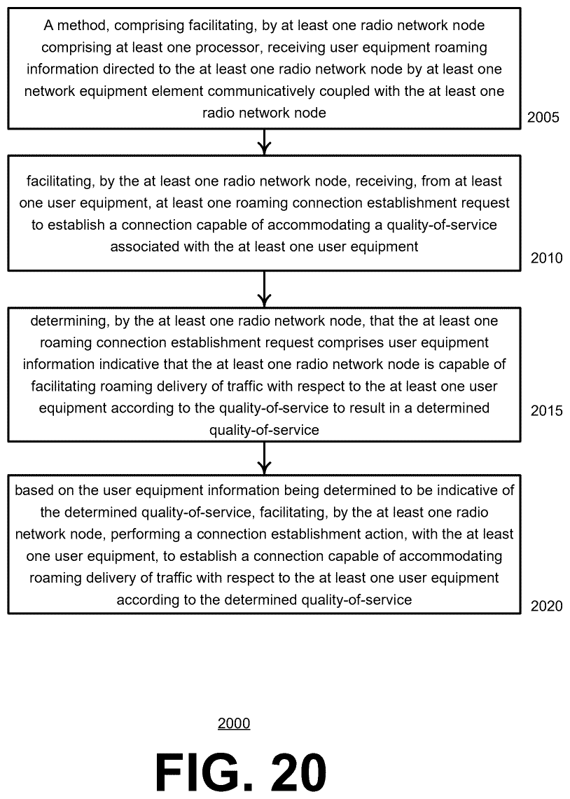

Turning now to FIG. 20, the figure illustrates an example embodiment method 2000 comprising, at block 2005, facilitating, by at least one radio network node comprising at least one processor, receiving user equipment roaming information directed to the at least one radio network node by at least one network equipment element communicatively coupled with the at least one radio network node; at block 2010 facilitating, by the at least one radio network node, receiving, from at least one user equipment, at least one roaming connection establishment request to establish a connection capable of accommodating a quality-of-service associated with the at least one user equipment; at block 2015 determining, by the at least one radio network node, that the at least one roaming connection establishment request comprises user equipment information indicative that the at least one radio network node is capable of facilitating roaming delivery of traffic with respect to the at least one user equipment according to the quality-of-service to result in a determined quality-of-service; and at block 2020, based on the user equipment information being determined to be indicative of the determined quality-of-service, facilitating, by the at least one radio network node, performing a connection establishment action, with the at least one user equipment, to establish a connection capable of accommodating roaming delivery of traffic with respect to the at least one user equipment according to the determined quality-of-service.

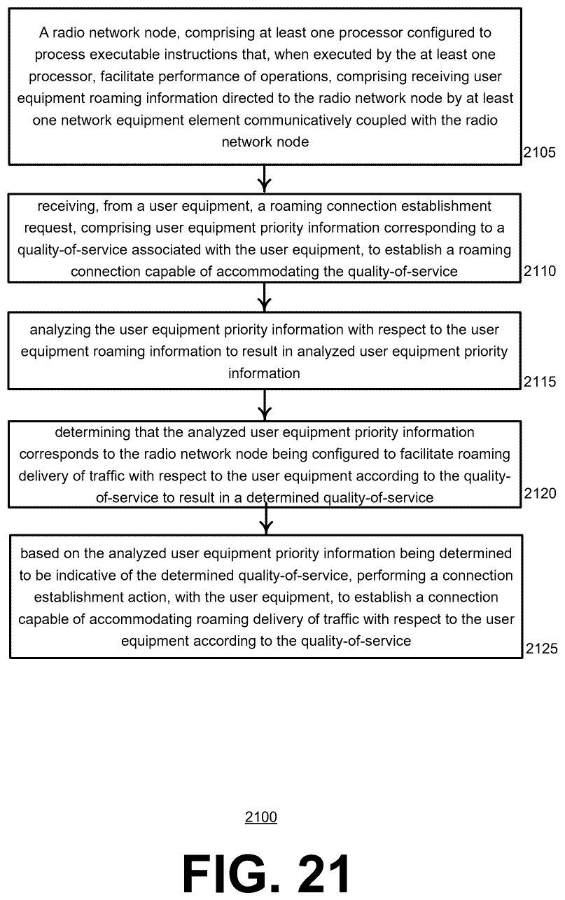

Turning now to FIG. 21, the figure illustrates an example non-terrestrial radio network node 2100, comprising at block 2105 at least one processor configured to process executable instructions that, when executed by the at least one processor, facilitate performance of operations, comprising receiving user equipment roaming information directed to the radio network node by at least one network equipment element communicatively coupled with the radio network node; at block 2110 receiving, from a user equipment, a roaming connection establishment request, comprising user equipment priority information corresponding to a quality-of-service associated with the user equipment, to establish a roaming connection capable of accommodating the quality-of-service; at block 2115 analyzing the user equipment priority information with respect to the user equipment roaming information to result in analyzed user equipment priority information; at block 2120 determining that the analyzed user equipment priority information corresponds to the radio network node being configured to facilitate roaming delivery of traffic with respect to the user equipment according to the quality-of-service to result in a determined quality-of-service; and at block 2125 based on the analyzed user equipment priority information being determined to be indicative of the determined quality-of-service, performing a connection establishment action, with the user equipment, to establish a connection capable of accommodating roaming delivery of traffic with respect to the user equipment according to the quality-of-service.

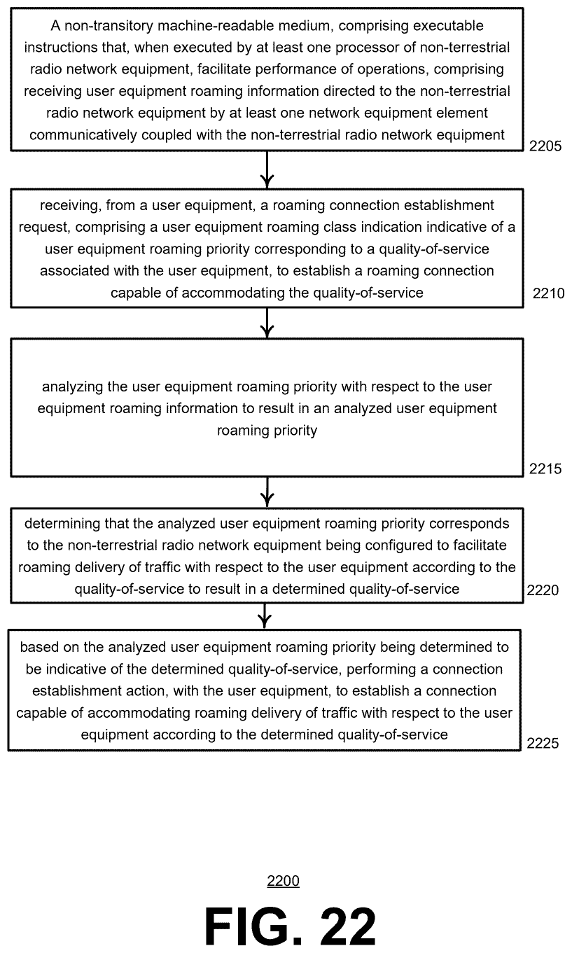

Turning now to FIG. 22, the figure illustrates a non-transitory machine-readable medium 2200 comprising at block 2205 executable instructions that, when executed by at least one processor of a non-terrestrial radio network node, facilitate performance of operations, comprising receiving user equipment roaming information directed to the non-terrestrial radio network equipment by at least one network equipment element communicatively coupled with the non-terrestrial radio network equipment; at block 2210 receiving, from a user equipment, a roaming connection establishment request, comprising a user equipment roaming class indication indicative of a user equipment roaming priority corresponding to a quality-of-service associated with the user equipment, to establish a roaming connection capable of accommodating the quality-of-service; at block 2215 analyzing the user equipment roaming priority with respect to the user equipment roaming information to result in an analyzed user equipment roaming priority; at block 2220 determining that the analyzed user equipment roaming priority corresponds to the non-terrestrial radio network equipment being configured to facilitate roaming delivery of traffic with respect to the user equipment according to the quality-of-service to result in a determined quality-of-service; and at block 2225 based on the analyzed user equipment roaming priority being determined to be indicative of the determined quality-of-service, performing a connection establishment action, with the user equipment, to establish a connection capable of accommodating roaming delivery of traffic with respect to the user equipment according to the determined quality-of-service.

In order to provide additional context for various embodiments described herein, FIG. 23 and the following discussion are intended to provide a brief, general description of a suitable computing environment 2300 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 23, the example environment 2300 for implementing various embodiments of the aspects described herein includes a computer 2302, the computer 2302 including a processing unit 2304, a system memory 2306 and a system bus 2308. The system bus 2308 couples system components including, but not limited to, the system memory 2306 to the processing unit 2304. The processing unit 2304 can be any of various commercially available processors and may include a cache memory. Dual microprocessors and other multi-processor architectures can also be employed as the processing unit 2304.

The system bus 2308 can be any of several types of bus structure that can further interconnect to a memory bus (with or without a memory controller), a peripheral bus, and a local bus using any of a variety of commercially available bus architectures. The system memory 2306 includes ROM 2310 and RAM 2312. A basic input/output system (BIOS) can be stored in a non-volatile memory such as ROM, erasable programmable read only memory (EPROM), EEPROM, which BIOS contains the basic routines that help to transfer information between elements within the computer 2302, such as during startup. The RAM 2312 can also include a high-speed RAM such as static RAM for caching data.

Computer 2302 further includes an internal hard disk drive (HDD) 2314 (e.g., EIDE, SATA), one or more external storage devices 2316 (e.g., a magnetic floppy disk drive (FDD) 2316, a memory stick or flash drive reader, a memory card reader, etc.) and an optical disk drive 2320 (e.g., which can read or write from a CD-ROM disc, a DVD, a BD, etc.). While the internal HDD 2314 is illustrated as located within the computer 2302, the internal HDD 2314 can also be configured for external use in a suitable chassis (not shown). Additionally, while not shown in environment 2300, a solid-state drive (SSD) could be used in addition to, or in place of, an HDD 2314. The HDD 2314, external storage device(s) 2316 and optical disk drive 2320 can be connected to the system bus 2308 by an HDD interface 2324, an external storage interface 2326 and an optical drive interface 2328, respectively. The interface 2324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2312, including an operating system 2330, one or more application programs 2332, other program modules 2334 and program data 2336. All or portions of the operating system, applications, modules, and/or data can also be cached in the RAM 2312. The systems and methods described herein can be implemented utilizing various commercially available operating systems or combinations of operating systems.

Computer 2302 can optionally comprise emulation technologies. For example, a hypervisor (not shown) or other intermediary can emulate a hardware environment for operating system 2330, and the emulated hardware can optionally be different from the hardware illustrated in FIG. 23. In such an embodiment, operating system 2330 can comprise one virtual machine (VM) of multiple VMs hosted at computer 2302. Furthermore, operating system 2330 can provide runtime environments, such as the Java runtime environment or the .NET framework, for applications 2332. Runtime environments are consistent execution environments that allow applications 2332 to run on any operating system that includes the runtime environment. Similarly, operating system 2330 can support containers, and applications 2332 can be in the form of containers, which are lightweight, standalone, executable packages of software that include, e.g., code, runtime, system tools, system libraries and settings for an application.

Further, computer 2302 can comprise a security module, such as a trusted processing module (TPM). For instance, with a TPM, boot components hash next in time boot components, and wait for a match of results to secured values, before loading a next boot component. This process can take place at any layer in the code execution stack of computer 2302, e.g., applied at the application execution level or at the operating system (OS) kernel level, thereby enabling security at any level of code execution.

A user can enter commands and information into the computer 2302 through one or more wired/wireless input devices, e.g., a keyboard 2338, a touch screen 2340, and a pointing device, such as a mouse 2342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2304 through an input device interface 2344 that can be coupled to the system bus 2308, but can be connected by other interfaces, such as a parallel port, an IEEE 1394 serial port, a game port, a USB port, an IR interface, a BLUETOOTH® interface, etc.

A monitor 2346 or other type of display device can be also connected to the system bus 2308 via an interface, such as a video adapter 2348. In addition to the monitor 2346, a computer typically includes other peripheral output devices (not shown), such as speakers, printers, etc.

The computer 2302 can operate in a networked environment using logical connections via wired and/or wireless communications to one or more remote computers, such as a remote computer(s) 2350. The remote computer(s) 2350 can be a workstation, a server computer, a router, a personal computer, portable computer, microprocessor-based entertainment appliance, a peer device or other common network node, and typically includes many or all of the elements described relative to the computer 2302, although, for purposes of brevity, only a memory/storage device 2352 is illustrated. The logical connections depicted include wired/wireless connectivity to a local area network (LAN) 2354 and/or larger networks, e.g., a wide area network (WAN) 2356. Such LAN and WAN networking environments are commonplace in offices and companies, and facilitate enterprise-wide computer networks, such as intranets, all of which can connect to a global communications network, e.g., the internet.

When used in a LAN networking environment, the computer 2302 can be connected to the local network 2354 through a wired and/or wireless communication network interface or adapter 2358. The adapter 2358 can facilitate wired or wireless communication to the LAN 2354, which can also include a wireless access point (AP) disposed thereon for communicating with the adapter 2358 in a wireless mode.

When used in a WAN networking environment, the computer 2302 can include a modem 2360 or can be connected to a communications server on the WAN 2356 via other means for establishing communications over the WAN 2356, such as by way of the internet. The modem 2360, which can be internal or external and a wired or wireless device, can be connected to the system bus 2308 via the input device interface 2344. In a networked environment, program modules depicted relative to the computer 2302 or portions thereof, can be stored in the remote memory/storage device 2352. It will be appreciated that the network connections shown are example and other means of establishing a communications link between the computers can be used.

When used in either a LAN or WAN networking environment, the computer 2302 can access cloud storage systems or other network-based storage systems in addition to, or in place of, external storage devices 2316 as described above. Generally, a connection between the computer 2302 and a cloud storage system can be established over a LAN 2354 or WAN 2356 e.g., by the adapter 2358 or modem 2360, respectively. Upon connecting the computer 2302 to an associated cloud storage system, the external storage interface 2326 can, with the aid of the adapter 2358 and/or modem 2360, manage storage provided by the cloud storage system as it would other types of external storage. For instance, the external storage interface 2326 can be configured to provide access to cloud storage sources as if those sources were physically connected to the computer 2302.

The computer 2302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

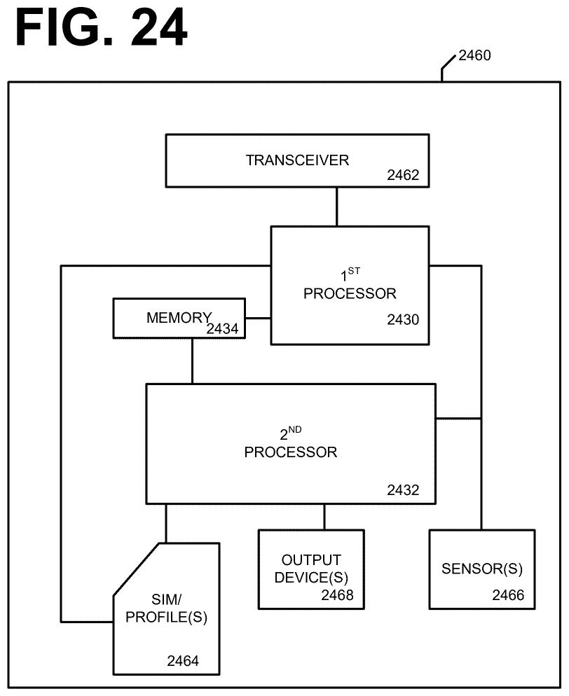

Turning to FIG. 24, the figure illustrates a block diagram of an example UE 2460. UE 2460 may comprise a smart phone, a wireless tablet, a laptop computer with wireless capability, a wearable device, a machine device that may facilitate vehicle telematics, a tracking device, remote sensing devices, and the like. UE 2460 comprises a first processor 2430, a second processor 2432, and a shared memory 2434. UE 2460 includes radio front end circuitry 2462, which may be referred to herein as a transceiver, but is understood to typically include transceiver circuitry, separate filters, and separate antennas for facilitating transmission and receiving of signals over a wireless link, such as one or more wireless links 125, 135, and 137 shown in FIG. 1. Furthermore, transceiver 2462 may comprise multiple sets of circuitry or may be tunable to accommodate different frequency ranges, different modulations schemes, or different communication protocols, to facilitate long-range wireless links such as links 125, device-to-device links, such as links 135, and short-range wireless links, such as links 137.

Continuing with description of FIG. 24, UE 2460 may also include a SIM 2464, or a SIM profile, which may comprise information stored in a memory (memory 2434 or a separate memory portion), for facilitating wireless communication with RAN 105 or core network 130 shown in FIG. 1. FIG. 24 shows SIM 2464 as a single component in the shape of a conventional SIM card, but it will be appreciated that SIM 2464 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 2464 and another device, which may be a component of RAN 105 or core network 130 shown in FIG. 1). A SIM profile 2464 may also comprise identifying information that is unique to the SIM, or SIM profile, such as, for example, an International Mobile Subscriber Identity (“IMSI”) or information that may make up an IMSI.

SIM 2464 is shown coupled to both the first processor portion 2430 and the second processor portion 2432. Such an implementation may provide an advantage that first processor portion 2430 may not need to request or receive information or data from SIM 2464 that second processor 2432 may request, thus eliminating the use of the first processor acting as a ‘go-between’ when the second processor uses information from the SIM in performing its functions and in executing applications. First processor 2430, which may be a modem processor or a baseband processor, is shown smaller than processor 2432, which may be a more sophisticated application processor, to visually indicate the relative levels of sophistication (i.e., processing capability and performance) and corresponding relative levels of operating power consumption levels between the two processor portions. Keeping the second processor portion 2432 asleep/inactive/in a low power state when UE 2460 does not need it for executing applications and processing data related to an application provides an advantage of reducing power consumption when the UE only needs to use the first processor portion 2430 while in listening mode for monitoring routine configured bearer management and mobility management/maintenance procedures, or for monitoring search spaces that the UE has been configured to monitor while the second processor portion remains inactive/asleep.

UE 2460 may also include sensors 2466, such as, for example, temperature sensors, accelerometers, gyroscopes, barometers, moisture sensors, and the like that may provide signals to the first processor 2430 or second processor 2432. Output devices 2468 may comprise, for example, one or more visual displays (e.g., computer monitors, VR appliances, and the like), acoustic transducers, such as speakers or microphones, vibration components, and the like. Output devices 2468 may comprise software that interfaces with output devices, for example, visual displays, speakers, microphones, touch sensation devices, smell or taste devices, and the like, that are external to UE 2460.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| AI | Artificial intelligence |
| ML | Machine learning |
| QCI | QoS Class Identifiers |
| BSR | Buffer status report |
| SBFD | Sub-band full duplex |
| CLI | Cross link interference |
| TDD | Time division duplexing |
| FDD | Frequency division duplexing |
| AI | Artificial intelligence |
| ML | Machine learning |
| MCS | Modulation and coding scheme |
| IE | Information element |
| BS | Base station |
| RRC | Radio resource control |
| UCI | Uplink control information |
| UE | User equipment |
| WTRU | Wireless transmit receive unit |
| CBR | Channel busy ratio |
| SCI | Sidelink control information |
| QOS | Quality of service |
| PER | Packet error rate |
| PDB | Packet delay budget |
| E2E | End to end |
| NES | Network energy saving |
| QCI | Quality class indication |
| RSRP | Reference signal received power |
| PCI | Primary cell ID |
| CSI-RS | Channel state information reference signals |
| PTRS | Phase tracking reference signals |
| DTX | Discontinuous transmission or discontinuous transmit |
| DRX | Discontinuous reception or discontinuous receive |
| CG | Configured grant |
| ULP | Uplink power |
| FBS | Fake base station |
| NTN | Non terrestrial network |
| gRAN | Ground radio access network |
| RAN | Radio access network |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
based on roaming priority information comprising at least one roaming priority indication indicative of at least one roaming priority associated with at least one quality-of-service, determining, by a first radio network node comprising at least one processor, at least one roaming priority that corresponds to at least one user equipment to result in at least one determined roaming priority; and
facilitating, by the first radio network node, transmitting, to the at least one user equipment, user equipment roaming information to be usable by the at least one user equipment to facilitate roaming delivery of traffic with respect to at least one second radio network node according to at least one of the at least one quality-of-service associated with the at least one determined roaming priority.

2. The method of claim 1, wherein the roaming priority information is received by the first radio network node from at least one network element associated with a core network.

3. The method of claim 1, wherein the user equipment roaming information comprises a determined priority indication indicative of the at least one determined roaming priority.

4. The method of claim 3, wherein the at least one determined roaming priority corresponds to a preferred quality-of-service that the at least one second radio network node is configured to accommodate with respect to the at least one user equipment.

5. The method of claim 1, wherein the user equipment roaming information comprises at least one non-terrestrial radio network node identifier indicative of the at least one second radio network node.

6. The method of claim 1, wherein the user equipment roaming information comprises a user equipment roaming class indication, indicative of at least one user equipment roaming class, corresponding to the at least one determined roaming priority, to be usable by the at least one user equipment to determine to request connection establishment with the at least one second radio network node.

7. The method of claim 1, further comprising:
facilitating, by the first radio network node, transmitting, to the at least one second radio network node, a user equipment roaming class indication, indicative of at least one user equipment roaming class, corresponding to the at least one determined roaming priority, to be usable by the at least one second radio network node, to determine at least one quality-of-service profile usable by the at least one second radio network node to facilitate a roaming communication session with the at least one user equipment according to the at least one of the at least one quality-of-service associated with the at least one determined roaming priority.

8. The method of claim 1, wherein the first radio network node is a terrestrial radio network node, and wherein the at least one second radio network node is a non-terrestrial radio network node.

9. The method of claim 1, further comprising:
facilitating, by the first radio network node, transmitting, to at least one of the at least one second radio network node, at least one of the at least one roaming priority indication to be indicative of at least one of the at least one roaming priority with respect to which the at least one second radio network node is to facilitate at least one communication session with the at least one user equipment.

10. The method of claim 9, wherein the at least one second radio network node is configured to facilitate broadcasting the at least one of the at least one roaming priority indication via at least one of: at least one master information block signal, or at least one system information block signal.

11. The method of claim 10, wherein the first radio network node is a terrestrial radio network node, and wherein the at least one second radio network node is a terrestrial radio network node.

12. A terrestrial radio network node, comprising at least one processor configured to process executable instructions that, when executed by the at least one processor, facilitate performance of operations, comprising:
receiving, from core network equipment, roaming priority information comprising at least one roaming priority indication respectively associated with at least one quality-of-service indication;
determining, from the roaming priority information, a roaming priority that corresponds to a session quality-of-service associated with a communication session with a user equipment to result in a determined roaming priority; and
transmitting, to the user equipment, user equipment roaming information to be usable by the user equipment to facilitate roaming delivery of traffic according to the session quality-of-service.

13. The terrestrial radio network node of claim 12, wherein the terrestrial radio network node is a serving terrestrial radio network node, wherein the user equipment roaming information comprises a determined user equipment roaming priority indication indicative of the determined roaming priority, and wherein the determined roaming priority corresponds to a preferred quality-of-service that at least one roaming terrestrial radio network node, other than the serving terrestrial radio network node, is configured to accommodate with respect to the user equipment.

14. The terrestrial radio network node of claim 13, wherein the operations further comprise:
transmitting, to the at least one roaming terrestrial radio network node, at least one roaming priority indication to be indicative, to the at least one roaming terrestrial radio network node, of at least the determined roaming priority with respect to which the at least one roaming terrestrial radio network node is to facilitate the communication session according to the session quality-of-service.

15. The terrestrial radio network node of claim 12, wherein the user equipment roaming information comprises a user equipment roaming class indication indicative of a user equipment roaming class, corresponding to the determined roaming priority, to be usable by the user equipment to determine to request connection establishment with a non-terrestrial radio network node.

16. The terrestrial radio network node of claim 12, wherein the operations further comprise:
transmitting, to a non-terrestrial radio network node, at least one user equipment roaming class indication to be indicative to the non-terrestrial radio network node of at least one user equipment roaming class to be usable by the non-terrestrial radio network node to determine a quality-of-service profile to facilitate a roaming communication session with the user equipment according to the session quality-of-service.

17. A non-transitory machine-readable medium, comprising executable instructions that, when executed by at least one processor of first radio network equipment, facilitate performance of operations, comprising:
receiving, from core network equipment, roaming priority information comprising at least one roaming priority indication respectively associated with at least one quality-of-service indication;
receiving a connection establishment request from a user equipment;
responsive to the connection establishment request, establishing a connection with the user equipment to result in an established connection;
facilitating a communication session, according to a session quality-of-service, with the user equipment via the established connection; and
transmitting, to the user equipment, user equipment roaming information to be usable by the user equipment to facilitate roaming delivery of traffic with respect to second radio network equipment according to the session quality-of-service.

18. The non-transitory machine-readable medium of claim 17, wherein the operations further comprise:
based on the roaming priority information, determining at least one user equipment roaming priority that corresponds to the session quality-of-service to result in at least one determined user equipment roaming priority,
wherein the user equipment roaming information comprises a determined user equipment roaming priority indication indicative of the at least one determined user equipment roaming priority, wherein the at least one determined user equipment roaming priority corresponds to a preferred quality-of-service that the second radio network equipment is configured to accommodate with respect to the user equipment, and wherein the second radio network equipment corresponds to a terrestrial radio network node.

19. The non-transitory machine-readable medium of claim 17, wherein the user equipment roaming information comprises a user equipment roaming class indication, indicative of at least one user equipment roaming class, to be usable by the user equipment to determine to request connection establishment from the second radio network equipment, and wherein the second radio network equipment corresponds to a non-terrestrial radio network node.

20. The non-transitory machine-readable medium of claim 19, wherein the operations further comprise:
transmitting, to the non-terrestrial radio network node, the user equipment roaming class indication to be indicative to the non-terrestrial radio network node of at least one user equipment roaming class to be usable by the non-terrestrial radio network node to determine a quality-of-service profile to facilitate a roaming communication session with the user equipment according to the session quality-of-service.
